(19) United States
(12) Patent Application Publication
(10) Pub. No.: US 2002/0052232 A1
(43) Pub. Date: May 2, 2002

(54) Apparatus and method for modifying generated values to determine an award in a gaming device

(76) Inventor: James E. Kaminkow, Reno, NV (US)

Correspondence Address: BELL, BOYD & LLOYD LLC, P. O. BOX 1135, CHICAGO, IL, 60690-1135, US

(21) Appl. No.: 09/957,018

(22) Filed: Sep. 20, 2001

Related U.S. Application Data
(63) Continuation-in-part of application No. 09/605,107, filed on Jun. 28, 2000.

(51) Int. Cl. A63F 9/24; A63F 13/00

(52) U.S. Cl. 463/20

(57) ABSTRACT

In a preferred embodiment, the present invention includes a plurality of player selectable inputs. When the player picks a input, the game generates a value. The game places values into a plurality of graphically displayed sets of values. The game applies at least one Boolean operator to the values of said sets and generates awards, for example, chooses the highest of Value 1 OR Value 2 OR Value 3. The game applies at least one mathematical operator to the awards and generates and provides a paid award to the player, for example, provides Award 1+Award 2+Award 3.

### PRIORITY CLAIM

This application is a continuation-in-part of U.S. patent application Ser. No. 09/605,107, filed Jun. 28, 2000, the entire contents of which are hereby incorporated by reference and relied upon.

### CROSS REFERENCE TO RELATED APPLICATIONS

This application relates to the following co-pending commonly owned patent applications: “GAMING DEVICE HAVING PYRAMID BONUS SCHEME,” Ser. No. 09/656,702, Attorney Docket No. 0112300-008; “GAMING DEVICE HAVING MULTIPLE AWARD ENHANCING LEVELS,” Ser. No. 09/626,720, Attorney Docket No. 0112300-014; “GAMING DEVICE HAVING A METHOD FOR RANDOMLY GENERATING A BONUS ROUND OUTCOME,” Ser. No. 09/679,251, Attorney Docket No. 0112300-019; “GAMING DEVICE WITH PRIZE BONUS SCHEME HAVING MULTIPLE AWARD LEVELS,” Ser. No. 09/602,140, Attorney Docket No. 0112300-023; “GAMING DEVICE HAVING COMPETITION BONUS SCHEME,” Ser. No. 09/628,144, Attorney Docket No. 0112300-028; “GAMING DEVICE HAVING A MULTIPLE SCREEN BONUS ROUND,” Ser. No. 09/629,235, Attorney Docket No. 0112300-086; “GAMING DEVICE HAVING A MULTI-ROUND BONUS SCHEME WHEREIN EACH ROUND HAS A PROBABILITY OF SUCCESS,” Ser. No. 09/688,441, Attorney Docket No. 0112300-141; “GAMING DEVICE HAVING MULTIPLE CHOICE LARGE AWARD BONUS SCHEME,” Ser. No. 09/686,284, Attorney Docket No. 0112300-143; “GAMING DEVICE HAVING A MULTIPLE SELECTION SET BONUS SCHEME,” Ser. No. 09/680,592, Attorney Docket No. 0112300-148; “GAMING DEVICE WITH A BONUS SCHEME INVOLVING MOVEMENT ALONG PATHS WITH PATH CHANGE CONDITIONS,” Ser. No. 09/686,538, Attorney Docket No. 0112300-149; “GAMING DEVICE HAVING RELATED MULTI-GAME BONUS SCHEME,” Ser. No. 09/688,972, Attorney Docket No. 0112300-158; “GAMING DEVICE WITH A BONUS SCHEME HAVING REPEATED SELECTION OF VALUE SETS WITH OPTION TO SAVE VALUES,” Ser. No. 09/684,533, Attorney Docket No. 0112300-469; “GAMING DEVICE HAVING A MULTIPLE SELECTION AND AWARD DISTRIBUTION BONUS SCHEME,” Ser. No. 09/688,635, Attorney Docket No. 0112300-476; “GAMING DEVICE HAVING AN ELEMENT AND ELEMENT GROUP SELECTION AND ELIMINATION BONUS SCHEME,” Ser. No. 09/689,381, Attorney Docket No. 0112300-478; and “GAMING DEVICE HAVING A BONUS SCHEME WITH MULTIPLE POTENTIAL AWARD SETS,” Ser. No. 09/822,697, Attorney Docket No. 0112300-592.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### DESCRIPTION

The present invention relates in general to a gaming device, and more particularly to a gaming device which modifies generated values to determine an award for the player.

### BACKGROUND OF THE INVENTION

Known bonus games in gaming devices display possible awards to a player and enable players to choose to accept or reject an offer of one of the displayed awards. The TOP DOLLAR® gaming device which is manufactured and distributed by the assignee of this application, provides the player with three offers and a final award. When an offer is given, the player may accept or reject it. If the player accepts an offer, the player receives the accepted bonus amount and the bonus round terminates. If the player declines an offer, the game generates another offer for the player, which may be a higher or lower offer.

Known bonus games also provide an award associated with a masked input. European Patent Application No. EP 0 945 837 A2 filed on Mar. 18, 1999 and assigned on its face to WMS Gaming, Inc. discloses a bonus game in which a player has one or more opportunities to select masked bonus awards. When the player selects a masked award, the game reveals the selection and provides the award to the player. The player selects until selecting a game terminator.

The known offer/acceptance games provide one award to the player, which the player has attempted to maximize. The known pick-until games combine one or more player selected awards to determine an overall award. In the known games, therefore, the player receives the award(s) which the player picks, either through an optionization process or an accumulation process. In an effort to develop new and exciting games for the player, a need exists to provide a game of a gaming device that compares the player's picks and selects the best pick for the player.

### SUMMARY OF THE INVENTION

In one preferred embodiment, the present invention includes a plurality of player selectable inputs. When the player picks an input, the game generates a value. The game places values into a plurality of graphically displayed sets of values. The game applies at least one Boolean operator to the values within the sets and generates awards, for example, chooses the highest of Value 1 OR Value 2 OR Value 3. The game performs at least one mathematical operation with the awards and generates and provides an award to the player, for example, provides Award 1+Award 2+Award 3.

In a first alternative embodiment, the present invention includes a plurality of player selectable inputs. When the player picks an input, the game generates a value. The game places values into a plurality of graphically displayed sets of values. The game applies at least one Boolean operator to the values within the sets and generates awards, for example, chooses the highest of Value 1 OR Value 2 OR Value 3. The game applies at least one other Boolean operator to the awards and generates and provides an award to the player, for example, provides the highest of Award 1 OR Award 2 OR Award 3.

In a second alternative embodiment, the present invention includes a plurality of player selectable inputs. When the player picks an input, the game generates a value. The game places values into a plurality of graphically displayed sets of values. The game applies at least one Boolean operator to the values of different graphically displayed sets and generates awards, for example, chooses the highest of Value 1 AND Value 2 OR Value 3. The game performs at least one mathematical operation with the awards and generates and provides an award to the player, for example, provides Award 1+Award 2−Award 3.

In a third alternative embodiment, the present invention includes a plurality of player selectable inputs. When the player picks an input, the game generates a value. The game places values into a plurality of graphically displayed sets of values. The game applies at least one Boolean operator to the values of different graphically displayed sets and generates awards, for example, chooses the highest of Value 1 AND Value 2 OR Value 3. The game applies at least one other Boolean operator to the awards and generates and provides an award to the player, for example, provides the highest of Award 1 OR Award 2 OR Award 3.

In a fourth alternative embodiment, the present invention includes a plurality of player selectable inputs. When the player picks an input, the game generates a value. The game places values into a plurality of graphically displayed sets of values. The game performs at least one mathematical operation with the values within the sets and generates awards, for example, performs the function of Value 1+Value 2+Value 3. The game performs at least one mathematical operation with the awards and generates and provides an award to the player, for example, provides Award 1+Award 2+Award 3.

In a fifth alternative embodiment, the present invention includes a plurality of player selectable inputs. When the player picks an input, the game generates a value. The game places values into a plurality of graphically displayed sets of values. The game performs at least one mathematical operation with the values within the sets and generates awards, for example, performs the function of Value 1+Value 2+Value 3. The game applies at least one other Boolean operator to the awards and generates and provides an award to the player, for example, provides the highest of Award 1 OR Award 2 OR Award 3.

In a sixth alternative embodiment, the present invention includes a plurality of player selectable inputs. When the player picks an input, the game generates a value. The game places values into a plurality of graphically displayed sets of values. The game performs at least one mathematical operation with the values of different graphically displayed sets and generates awards, for example, performs the function of Value 1+Value 2+Value 3. The game performs at least one mathematical operation with the awards and generates and provides an award to the player, for example, provides Award 1 +Award 2−Award 3.

In a seventh alternative embodiment, the present invention includes a plurality of player selectable inputs. When the player picks an input, the game generates a value. The game places values into a plurality of graphically displayed sets of values. The game performs at least one mathematical operation with the values of different graphically displayed sets and generates awards, for example, performs the function of Value 1+Value 2+Value 3. The game applies at least one other Boolean operator to the awards and generates and provides an award to the player, for example, provides the highest of Award 1 OR Award 2 OR Award 3.

It is therefore an advantage of the present invention to provide a gaming device which compares, selects and modifies values to determine the player's award.

Another advantage of the present invention is to provide a gaming device which modifies values, compares and selects an award to determine the player's award.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1A is a front-side perspective view of one embodiment of the gaming device of the present invention.

FIG. 1B is a front-side perspective view of another embodiment of the gaming device of the present invention.

FIG. 2 is a schematic block diagram of the electronic configuration of one embodiment of the gaming device of the present invention.

FIGS. 3A through 3F are front elevation views of one of the display devices of FIGS. 1A and 1B illustrating one preferred embodiment, wherein the game compares and selects an award from a plurality of sets of values and modifies the selected awards.

FIG. 3G is a front elevation view of one the display devices of FIGS. 1A and 1B, illustrating one alternative embodiment, wherein the game compares and selects awards from a plurality of sets of values and compares the selected awards.

FIGS. 4A through 4D are schematic representations of award tables, inputs and player picks, which illustrate a plurality of award assignment methods.

FIGS. 5A through 5E are front elevation views of one of the display devices of FIGS. 1A and 1B illustrating one alternative embodiment, wherein the game compares and selects awards from values of different sets of values and modifies the selected awards.

FIG. 5F is a front elevation view of one the display devices of FIGS. 1A and 1B, illustrating one alternative embodiment, wherein the game compares and selects awards from values of different sets of values and compares the selected awards.

FIGS. 6A through 6E are front elevation views of one of the display devices of FIGS. 1A and 1B illustrating one alternative embodiment, wherein the game modifies values of a plurality of sets of values to form awards and compares the awards.

FIG. 6F is a front elevation view of one the display devices of FIGS. 1A and 1B, illustrating one alternative embodiment, wherein the game modifies values of a plurality of sets of values to form awards and modifies the awards.

FIGS. 7A through 7E are front elevation views of one of the display devices of FIGS. 1A and 1B illustrating one alternative embodiment, wherein the game modifies values from different sets of values to form awards and compares the awards.

FIG. 7F is front elevation view of one of the display devices of FIGS. 1A and 1B illustrating one alternative embodiment, wherein the game modifies values from different sets of values to form awards and modifies the awards.

FIG. 8 is a front elevation view of one of the display devices of FIGS. 1A and 1B illustrating one embodiment, wherein the different sets are food plates and the displayed values include accompanying food items.

### DETAILED DESCRIPTION OF THE INVENTION

### Gaming Device and Electronics

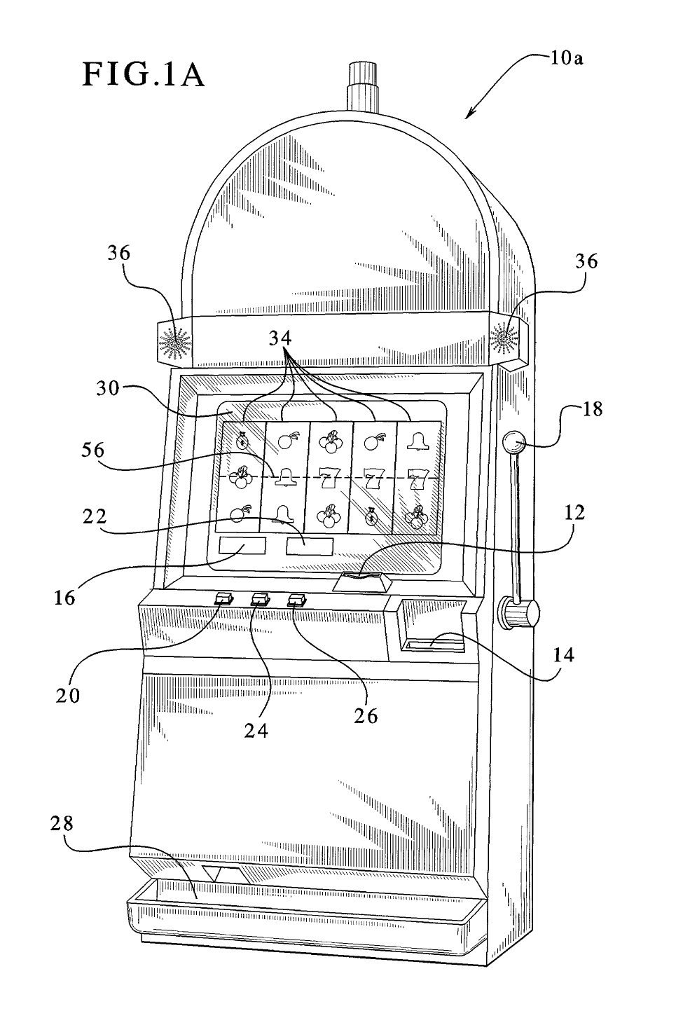

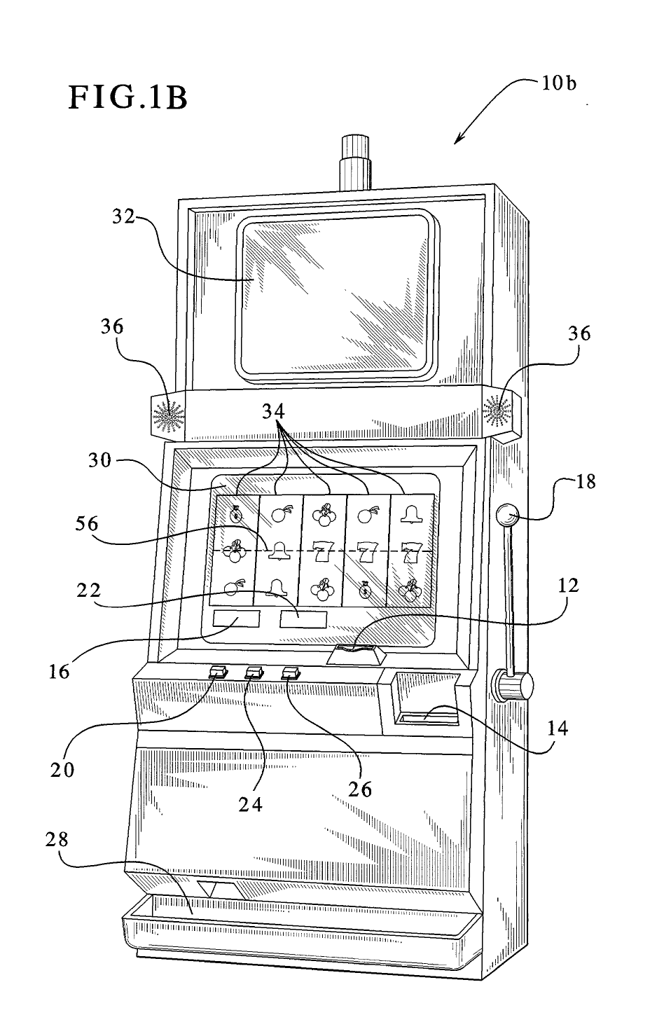

Referring now to the drawings, and in particular to FIGS. 1A and 1B, gaming device 10a and gaming device 10b illustrate two possible cabinet styles and display arrangements and are collectively referred to herein as gaming device 10. The present invention includes the game (described below) being a stand alone game or a bonus or secondary game that coordinates with a base game. When the game of the present invention is a bonus game, gaming device 10 in one base game is a slot machine having the controls, displays and features of a conventional slot machine, wherein the player operates the gaming device while standing or sitting. Gaming device 10 also includes being a pub-style or table-top game (not shown), which a player operates while sitting.

The base games of the gaming device 10 include slot, poker, blackjack or keno, among others. The gaming device 10 also embodies any bonus triggering events, bonus games as well as any progressive game coordinating with these base games, The symbols and indicia used for any of the base, bonus and progressive games include mechanical, electrical or video symbols and indicia.

In a stand alone or a bonus embodiment, the gaming device 10 includes monetary inputs. FIGS. 1A and 1B illustrate a coin slot 12 for coins or tokens and/or a payment acceptor 14 for cash money. The payment acceptor 14 also includes other devices for accepting payment, such as readers or validators for credit cards, debit cards or smart cards, tickets, notes, etc. When a player inserts money in gaming device 10, a number of credits corresponding to the amount deposited is shown in a credit display 16. After depositing the appropriate amount of money, a player can begin the game by pulling arm 18 or pushing play button 20. Play button 20 can be any play activator used by the player which starts any game or sequence of events in the gaming device.

As shown in FIGS. 1A and 1B, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one. At any time during the game, a player may “cash out” by pushing a cash out button 26 to receive coins or tokens in the coin payout tray 28 or other forms of payment, such as an amount printed on a ticket or credited to a credit card, debit card or smart card. Well known ticket printing and card reading machines (not illustrated) are commercially available.

Gaming device 10 also includes one or more display devices. The embodiment shown in FIG. 1A includes a central display device 30, and the alternative embodiment shown in FIG. 1B includes a central display device 30 as well as an upper display device 32. The display devices display any visual representation or exhibition, including but not limited to movement of physical objects such as mechanical reels and wheels, dynamic lighting and video images. The display device includes any viewing surface such as glass, a video monitor or screen, a liquid crystal display or any other static or dynamic display mechanism. In a video poker, blackjack or other card gaming machine embodiment, the display device includes displaying one or more cards. In a keno embodiment, the display device includes displaying numbers.

The slot machine base game of gaming device 10 preferably displays a plurality of reels 34, preferably three to five reels 34, in mechanical or video form on one or more of the display devices. Each reel 34 displays a plurality of indicia such as bells, hearts, fruits, numbers, letters, bars or other images which preferably correspond to a theme associated with the gaming device 10. If the reels 34 are in video form, the display device displaying the video reels 34 is preferably a video monitor. Each base game, especially in the slot machine base game of the gaming device 10, includes speakers 36 for making sounds or playing music.

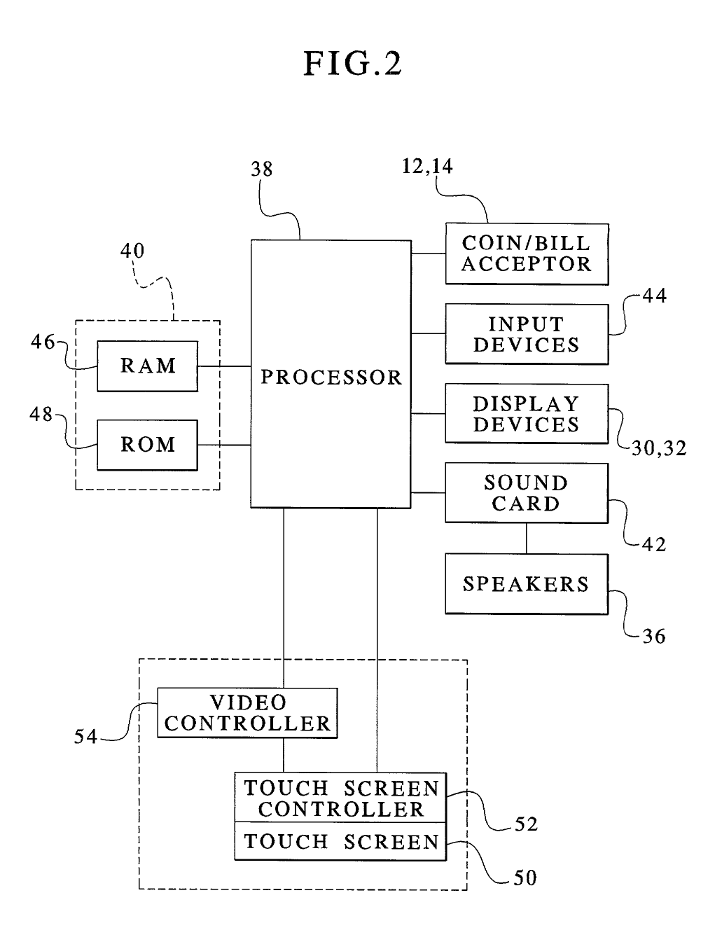

Referring now to FIG. 2, a general electronic configuration of the gaming device 10 for the stand alone and bonus embodiments described above preferably includes: a processor 38; a memory device 40 for storing program code or other data; a central display device 30; an upper display device 32; a sound card 42; a plurality of speakers 36; and one or more inputs 44. The processor 38 is preferably a microprocessor or microcontroller-based platform which is capable of displaying images, symbols and other indicia such as images of people, characters, places, things and faces of cards. The memory device 40 includes random access memory (RAM) 46 for storing event data or other data generated or used during a particular game. The memory device 40 also includes read only memory (ROM) 48 for storing program code, which controls the gaming device 10 so that it plays a particular game in accordance with applicable game rules and pay tables.

As illustrated in FIG. 2, the player preferably uses the inputs 44 to input signals into gaming device 10. In the slot machine base game, the inputs 44 include the pull arm 18, play button 20, the bet one button 24 and the cash out button 26. A touch screen 50 and touch screen controller 52 are connected to a video controller 54 and processor 38. The terms “computer” or “controller” are used herein to refer collectively to the processor 38, the memory device 40, the sound card 42, the touch screen controller and the video controller 54.

In certain instances, it is preferable to use a touch screen 50 and an associated touch screen controller 52 instead of a conventional video monitor display device. The touch screen enables a player to input decisions into the gaming device 10 by sending a discrete signal based on the area of the touch screen 50 that the player touches or presses. As further illustrated in FIG. 2, the processor 38 connects to the coin slot 12 or payment acceptor 14, whereby the processor 38 requires a player to deposit a certain amount of money in to start the game. For purposes of the present invention, the display device can alternatively include mechanical or electro-mechanical buttons or indicators for enabling the player to input decisions.

It should be appreciated that although a processor 38 and memory device 40 are preferable implementations of the present invention, the present invention also includes being implemented via one or more application-specific integrated circuits (ASIC's), one or more hard-wired devices, or one or more mechanical devices (collectively referred to herein as a “processor”). Furthermore, although the processor 38 and memory device 40 preferably reside in each gaming device 10 unit, the present invention includes providing some or all of their functions at a central location such as a network server for communication to a playing station such as over a local area network (LAN), wide area network (WAN), Internet connection, microwave link, and the like.

With reference to the slot machine base game of FIG. 1A and 1B, to operate the gaming device 10, the player inserts the appropriate amount of tokens or money in the coin slot 12 or the payment acceptor 14 and then pulls the arm 18 or pushes the play button 20. The reels 34 then begin to spin. Eventually, the reels 34 come to a stop. As long as the player has credits remaining, the player can spin the reels 34 again. Depending upon where the reels 34 stop, the player may or may not win additional credits.

In addition to winning base game credits, the gaming device 10, including any of the base games disclosed above, also includes bonus games that give players the opportunity to win credits. The gaming device 10 preferably employs a video-based display device 30 or 32 for the bonus games. The bonus games include a program that automatically begins when the player achieves a qualifying condition in the base game.

In the slot machine embodiment, the qualifying condition includes a particular symbol or symbol combination generated on a display device. As illustrated in the five reel slot game shown in FIGS. 1A and 1B, the qualifying condition includes the number seven appearing on three adjacent reels 34 along a payline 56. It should be appreciated that the present invention includes one or more paylines, such as payline 56, wherein the paylines can be horizontal, diagonal or any combination thereof.

### Operations and Databases

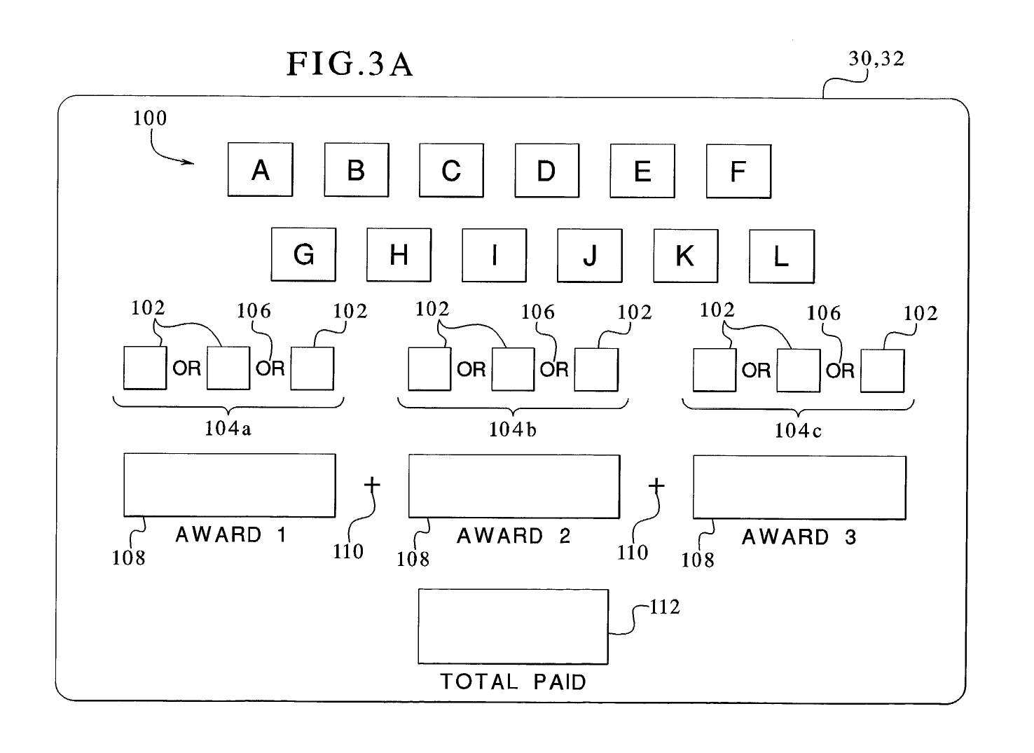

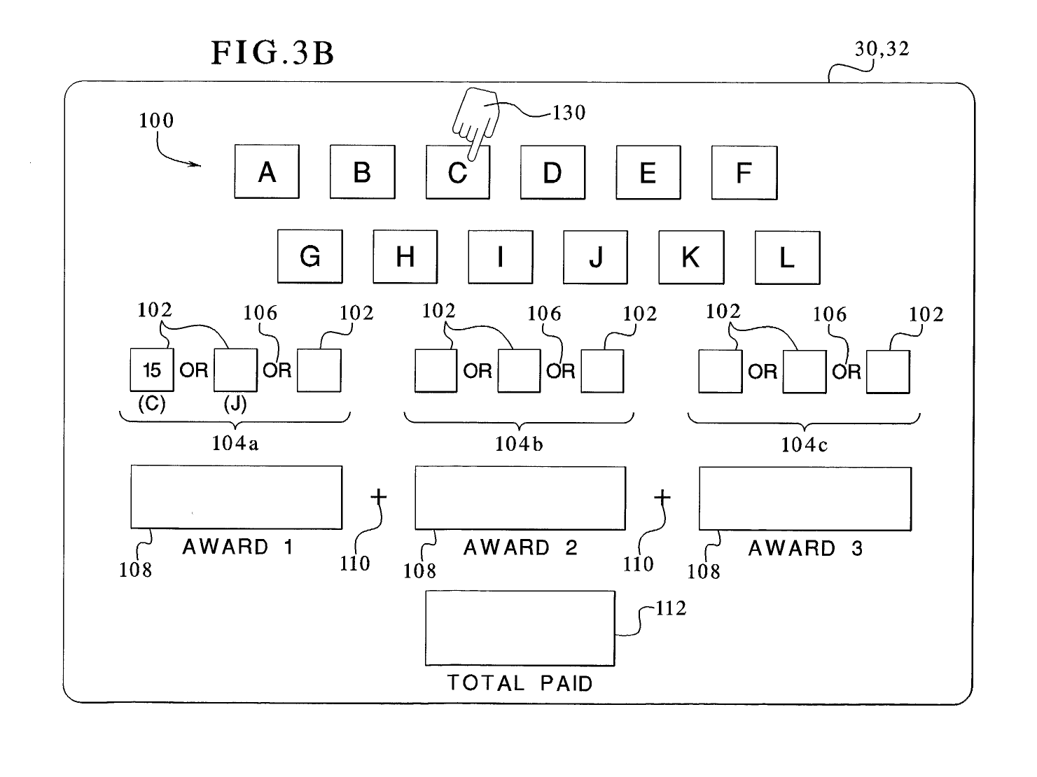

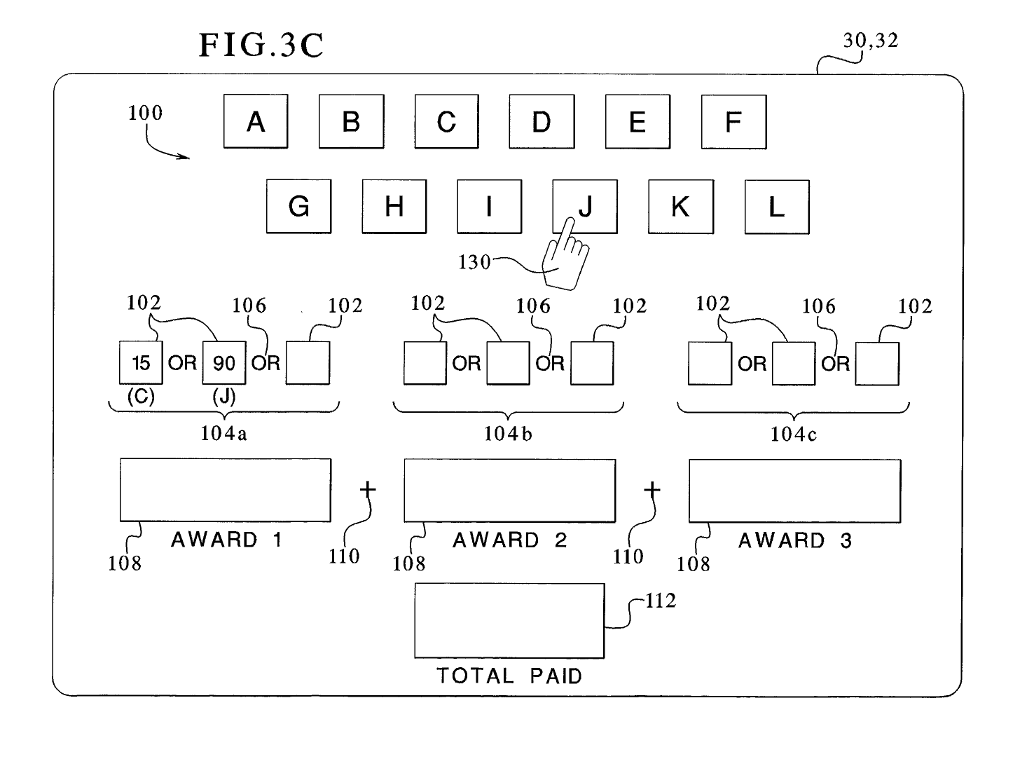

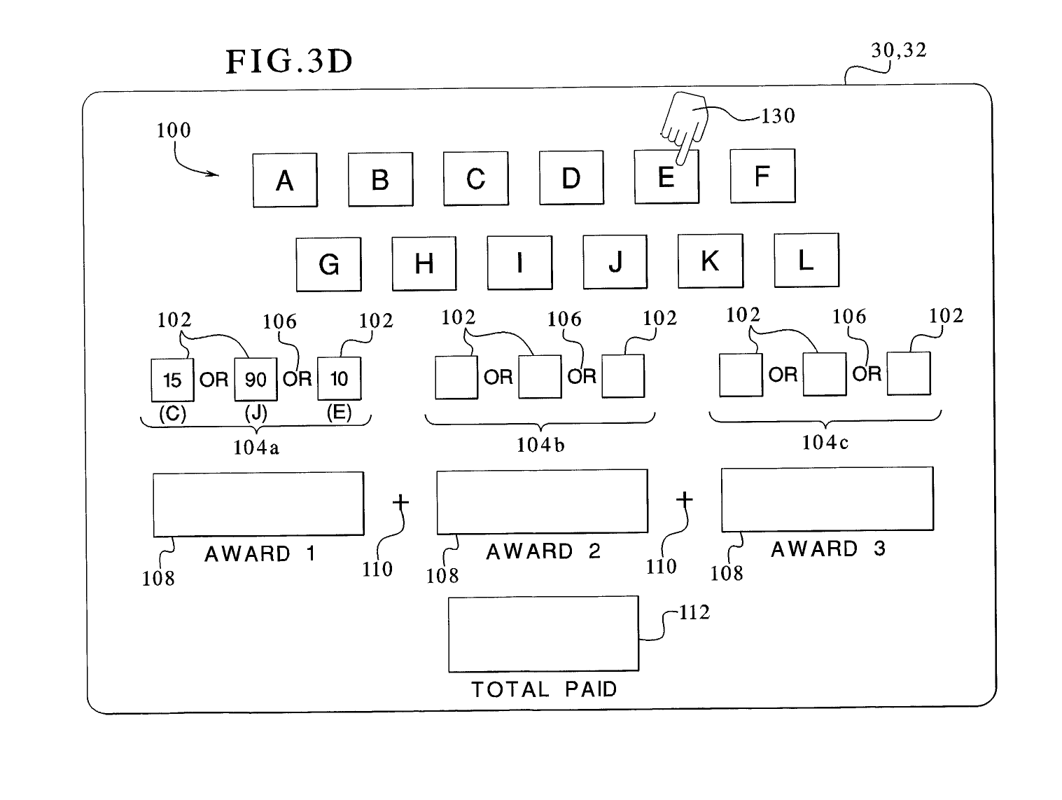

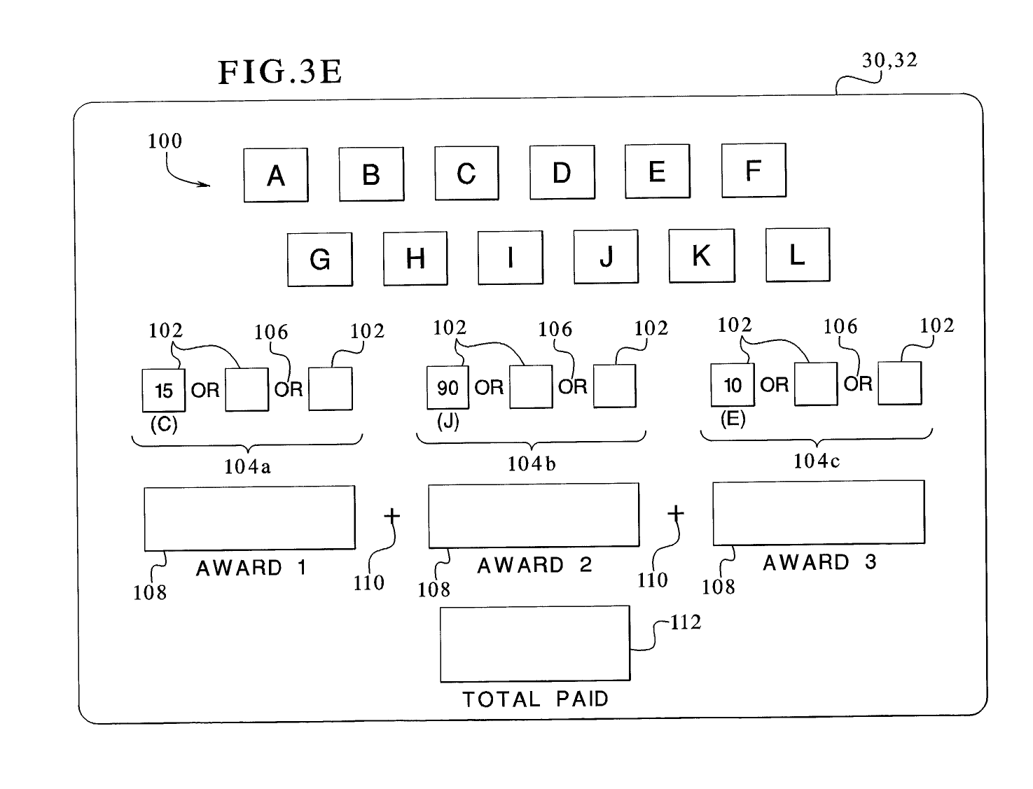

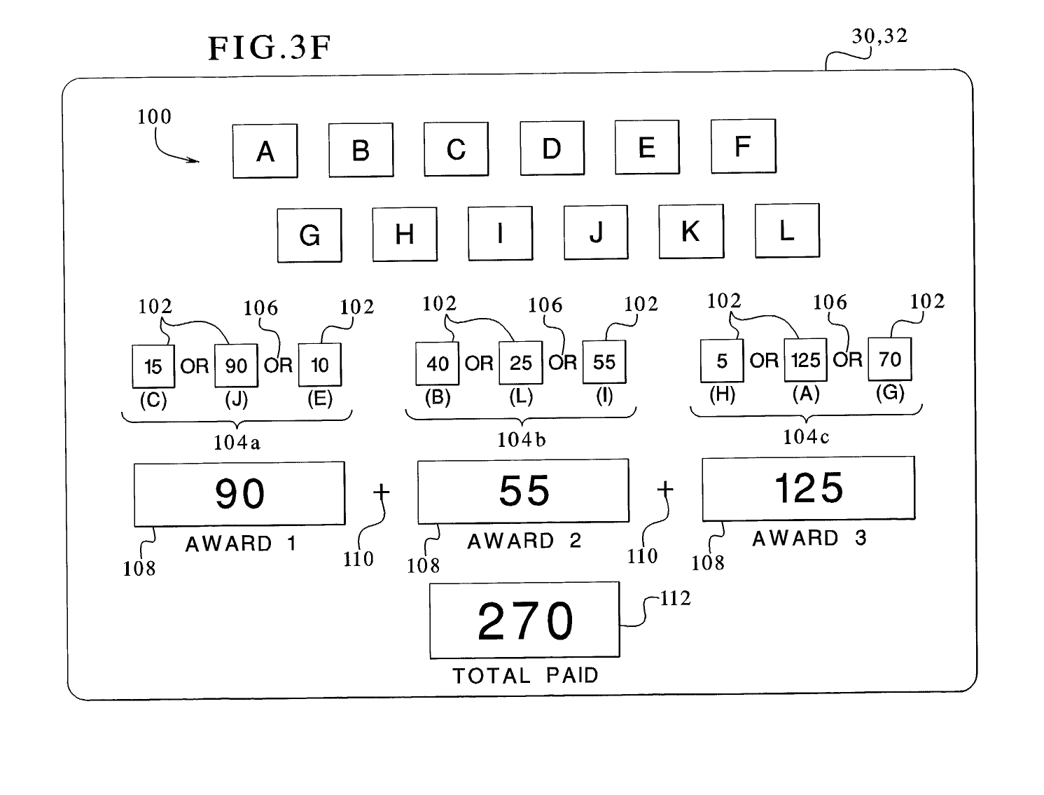

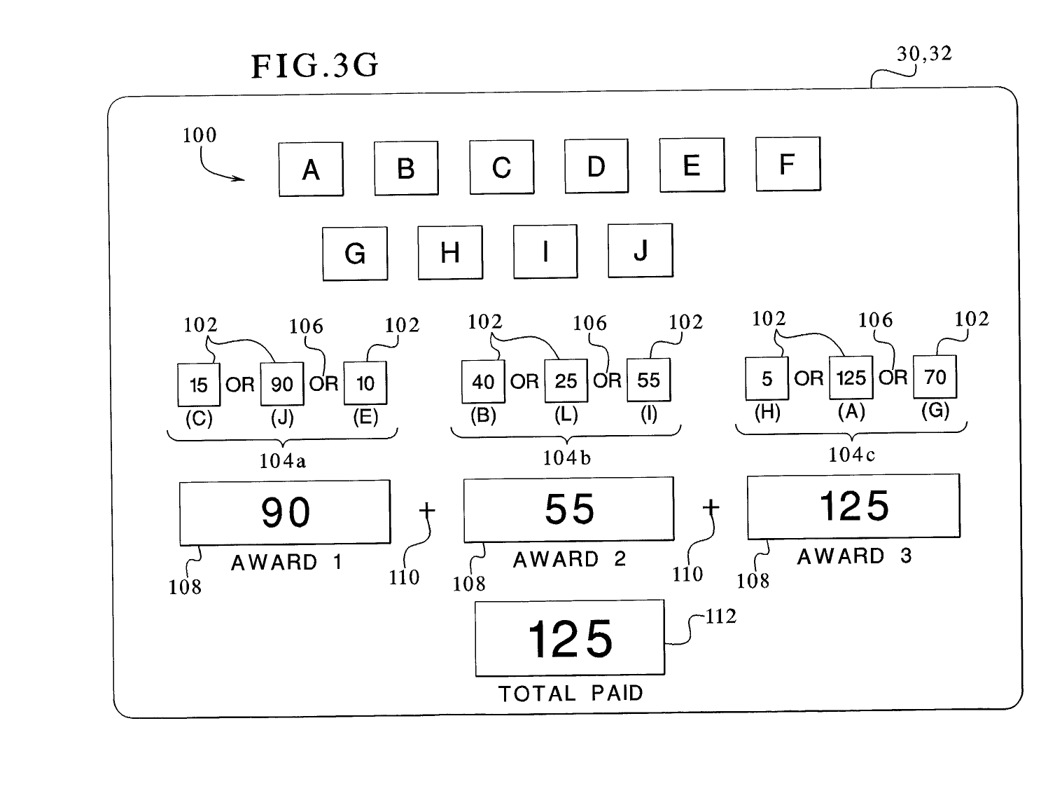

Referring now to FIG. 3A, one of the display devices 30 or 32 illustrates one preferred embodiment, wherein: (i) the player selects values; (ii) the game places the values into sets; (iii) the game compares values of each set and determines an award for the set; and (iv) the game modifies the awards to determine an award to pay to the player. The preferred embodiment includes a plurality of inputs 100. FIG. 3A displays twelve inputs “A” through “L,” however, the present invention includes providing any desired suitable number of inputs.

When the player picks an input, the game determines a value and displays it in one of the value displays 102. The game groups the value displays 102 into value sets 104a through 104c. The value sets 104a through 104c include any graphically represented grouping of value displays 102, which are preferably visually distinguishable from other sets having other display areas. If any of the inputs remain unselected after the player finished picking the inputs, the gaming device 10 may be adapted to reveal values associated with the unselected inputs.

The value sets 104a through 104c preferably include other indicia that together with indicia associated with the value displays 102 form a theme. For example, in one preferred graphical representation, value set includes the graphical representation of a food dish or plate and the displays 102 include the graphical representation of food items. When the player picks inputs 100, which also include graphical indicia, and preferably the same or similar graphical indicia as the displays 102, the game adds food items or displays 102 to the dish or plate, i.e., to the value set 104.

In the preferred embodiment of FIG. 3A, the game applies one or more logic or Boolean operators 106 to the values generated for each display 102 of the set 104a through 104c. FIG. 3A graphically represents the Boolean operator 106 by displaying the word “OR” between the displays 102. An “OR” operator is the preferred Boolean operator 106 of the present invention, however, the present invention includes the “AND” Boolean operators, wherein the game, e.g., compares and selects the higher of (one value 102 AND another value 102) OR (a third value 102) of a set 104.

The game includes a plurality of award displays 108, in which the game displays a particular value or a modification of the values of an associated award set 104a through 104c. In the preferred embodiment of FIG. 3A, the game selects the highest or greatest value and displays it in the appropriate award display 108. The game alternatively selects the lowest value or an intermediate value as desired by the implementor and displays the value in the award display 108. Alternatively, the game could randomly select a value.

The game further includes mathematical operations indicated by operators. The preferred mathematical operation is addition (represented by the “+” sign operator), however, the game alternatively includes multiplication, division, subtraction or other suitable mathematical operations. In FIG. 3A, the game adds the awards of the award displays 108 to form the player's award, which is given to the player and displayed in the total paid display 112. The game alternatively includes multiplying the awards of the award displays 108 and displaying the total in the paid display 112. The game further alternatively includes dividing or subtracting the awards and displaying the total in the paid display 112. The game yet further alternatively includes any combination of addition, multiplication, division, subtraction or other mathematical operation. That is for example, the game includes multiplying Award 1 by Award 2 and dividing the product by Award 3.

The game preferably displays the inputs 100, value displays 102, value sets 104a through 104c, any indicia accompanying the values or sets, any displayed Boolean operator 106, the award displays 108, any displayed mathematical operator 110 and the paid display 112 on a video monitor. The game preferably employs a touch screen 50 and a touch screen controller 52 such that each input “A” through “L” is a separate player selectable area on the video monitor adapted to send an input to the processor 38, computer or controller, which is separate from the inputs sent by other inputs. The game may alternatively display one or more of the value displays 102, value sets 104, operators 106 and 110, award displays 108 and the paid display 112 using one or more lighted mechanical displays and may employ separate electromechanical inputs 44 (FIG. 2), similar to the bet one button 24 or the cash out button 26, as inputs 100 to enter inputs into the processor 38 or computer.

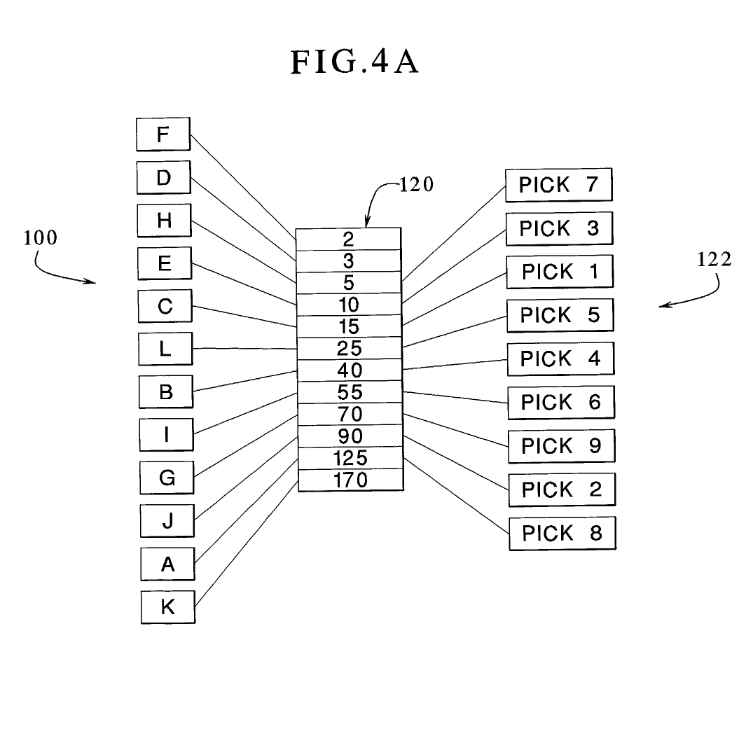

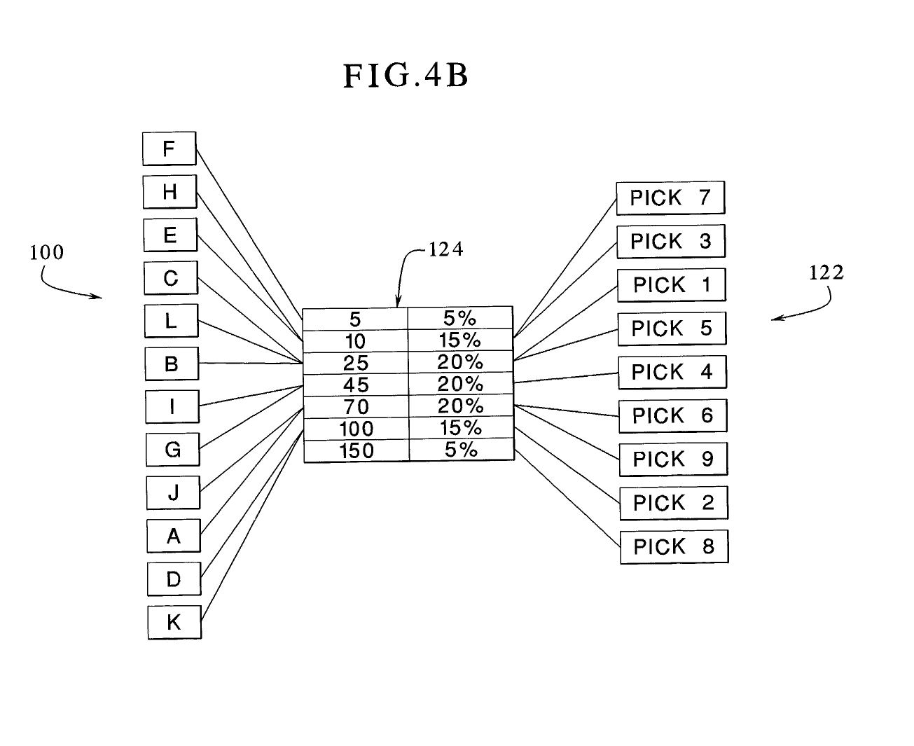

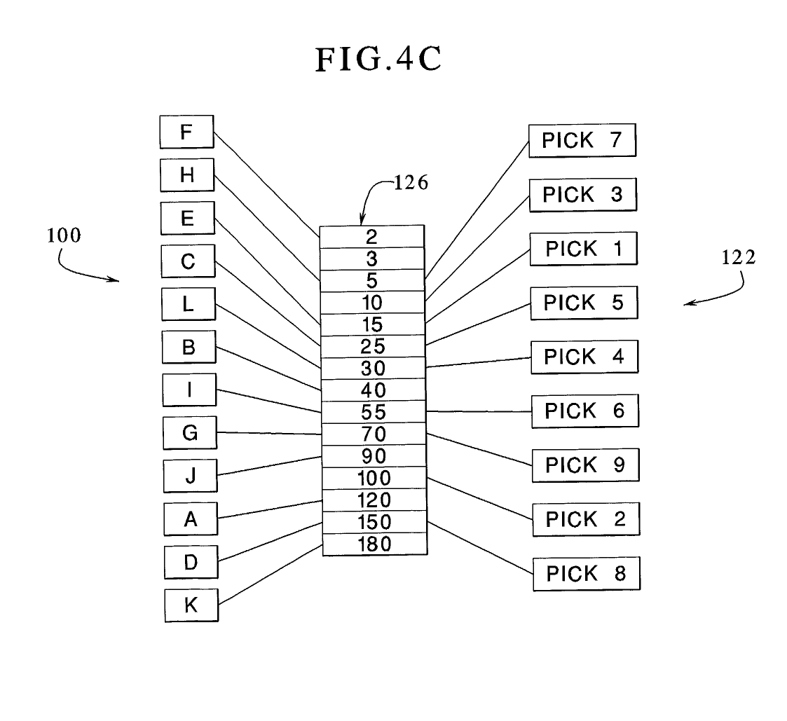

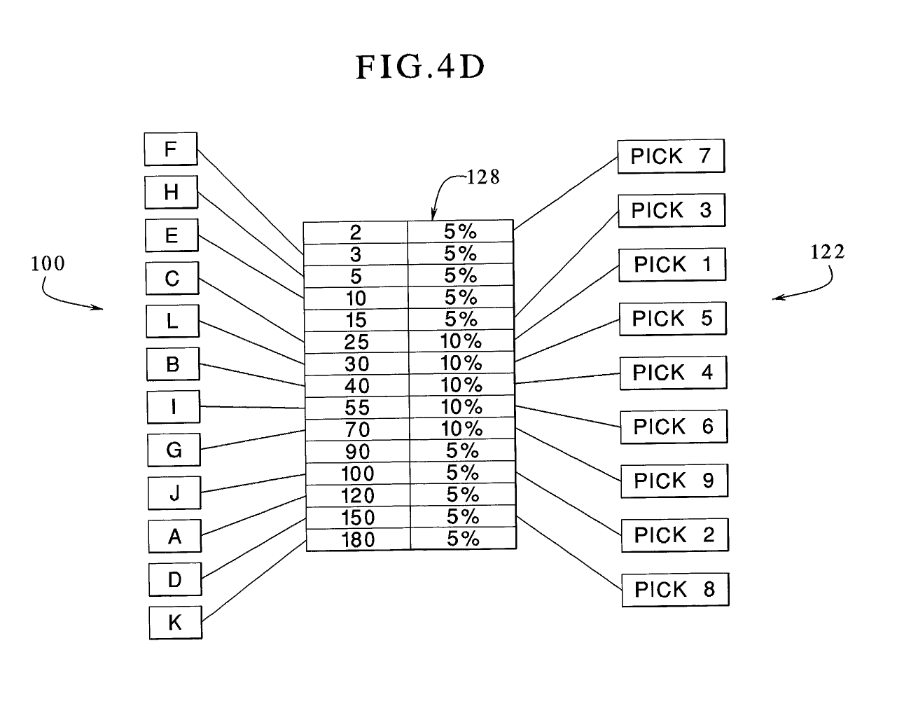

Referring now to FIGS. 4A through 4D, and in particular to FIG. 4A, a schematic representation including a value table 120 having a plurality of values, inputs “A” through “L” randomly displayed, and a pick order 122 wherein the picks are randomly displayed, illustrates two assignment methods contemplated by the present invention. The pick order 122 includes the numbers of the order in which a player picks, e.g., the player's first pick or pick 1, the player's second pick or pick 2, etc.

In a first method, the game randomly assigns a value from the table 120 to a input 100. FIG. 4A schematically illustrates that the game randomly assigns the “H” input to the five value, the “E” input to the ten value, the “C” input to the fifteen value, etc. In this example the value table 120 includes the same number of values as the number of inputs 100, and the game only assigns a particular value one time. As described below, a table preferably includes having more or less values than inputs and assigning a particular value a plurality of times.

Employing an alternative method, the game randomly assigns a value from the table 120 to a player's pick. FIG. 4A schematically illustrates that the game randomly assigns the five value to the seventh pick, the ten value to the third pick, the fifteen value to the first pick, etc. In this example the value table 120 includes more values than picks, i.e., than value displays 102 in FIG. 3A, and the game only assigns a particular value one time.

The game preferably assigns values to inputs 100 rather than to picks, so that the game is enabled to reveal unpicked inputs at the end. For example, FIG. 3A illustrates twelve inputs 100 and nine value displays 102. The game preferably reveals the values assigned to the three unpicked inputs after the player picks and completes the displays.

FIG. 4B is a schematic representation including a weighted value table 124 having a plurality of values with associated percentages indicating their likelihood of being assigned. The table 124 includes less values than inputs or picks. The percentages preferably add to 100%. The embodiment of FIG. 4B enables the game to assign the same value more than once. For instance, the game randomly assigns the twenty-five value to three inputs 100, namely, the “C,” “L” and “B” inputs. The game randomly assigns the seventy value to the sixth and the ninth pick. Here, the game is not required to assign every value. For instance, the game does not assign the 150 value to any input 100. The game does not assign the five value to any pick of the order 122.

FIG. 4C illustrates that the game includes providing a value table 126 having more values than inputs 100 or picks of a pick order 122. Although not illustrated as such, the present invention employing this table contemplates the game assigning the same value a plurality of times. FIG. 4D illustrates a variation of the value table 126 of FIG. 4C, wherein the weighted value table 128 weights the values. The likelihood of selection percentages preferably add to 100 percent. The game contemplates employing any of the above tables and methods in each of the embodiments hereafter described.

It should be appreciated that other suitable value determination methods may be employed in conjunction with the present invention. Referring now to FIG. 3B, in the preferred embodiment, the game compares and selects awards from a plurality of sets of values and modifies the selected awards. Assuming the game employs the table 120 of FIG. 4A, when the player 130 first selects the “C” input, the game displays the associated fifteen value (and any accompanying indicia) in the value set 104a associated with Award 1. FIG. 3B illustrates the “C” in parentheses below the value display 102 having the value fifteen for clarification purposes, and the game alternatively does not so illustrate the “C.”

Referring now to FIG. 3C, the player 130 selects the “J” input second, and the game displays the associated ninety value (and any accompanying indicia) in the same value set 104a associated with Award 1. Referring now to FIG. 3D, the player 130 selects the “E” input third, and the game displays the associated ten value (and any accompanying indicia) in the now completed set 104a associated with Award 1.

The preferred embodiment of FIGS. 3A through 3F contemplates displaying values for and completing value sets 104a through 104c one at a time, as illustrated by the FIGS. 3B through 3D. FIG. 3E illustrates an alternative method of distributing the same first three picks, wherein the game places the fifteen value associated with the first pick “C” in the value set 104a of Award 1, as done previously. The game however places the ninety value associated with the second pick “J” in the value set 104b of Award 2. The game places the ten value associated with the third pick “E” in the value set 104c of Award 3. The preferred embodiment includes employing any predetermined value placement order or further alternatively randomly deploying the values in the various sets 104a through 104c.

Referring now to FIG. 3F and assuming the game completes one set at a time as in FIGS. 3B through 3D and employs the value table 120 of FIG. 4A, upon making nine allowable selections, the game completed the set 104b of Award 2 after the player selected the “B,” the “L” and the “I'” and the set 104c of Award 3 after the player selected the “H,” the “A” and the “G.” In the preferred embodiment of FIGS. 3A through 3F, the game preferably applies one or more Boolean operators 106 and places the highest value display 102 of each set 104a through 104c into the associated award display 108. The game therefore places the 90 value into the Award 1 display, the 55 value into the Award 2 display and the 125 value into the Award 3 display.

The game alternatively applies one or more Boolean operators 106 and places the lowest value display 102 or an intermediate value display 102 from each set 104a through 104c into the associated award display 108. The game further alternatively does not apply a Boolean operator 106 and randomly places a value display 102 into the associated award display 108. The preferred embodiment also includes placing values in the award displays 108 individually after the game completes a set 104a through 104c or collectively after the game completes all the sets.

The game then performs one or more mathematical operations with any two or more awards as indicated by the mathematical operators 110, until performing a mathematical operation with each award. In FIG. 3F, as preferred, the game adds all three awards together. The game alternatively multiplies all three awards, adds two and multiplies the result by the third, multiplies two and adds the result to a third, multiplies or adds to and subtracts or divides the result by a third, etc. The preferred embodiment includes employing any single mathematical operation such as addition, subtraction, multiplication, division, any combination thereof or other suitable mathematical operation or calculation (i.e., such as square or factorial).

The game displays in the paid display 112 the result of performing one or more mathematical operations with the awards. The game also provides the resulting amount of credits or multipliers or other gaming device award such as a number of picks from a prize pool to the player. Providing the resulting amount to the player includes updating the player's credit display 16 (FIGS. 1A and 1B) as well as enabling the player to cash out and redeem an amount of credits generated by the resulting amount (either providing the amount if the result represents credits or multiplying a known credit amount if the result represents a multiplier).

### First Alternative Embodiment

Referring now to FIG. 3G, an alternative embodiment of the present invention is illustrated, wherein the game compares and selects awards from a plurality of sets of values and compares the selected awards. The embodiment of FIG. 3G includes employing any predetermined value placement or alternatively randomly deploying the values in the various sets 104a through 104c. Assuming the game completes one set at a time as in FIGS. 3B through 3D and employs the value table 120 of FIG. 4A, upon making nine allowable selections, the game completes the sets 104a through 104c as displayed.

In the alternative embodiment of FIG. 3G, the game preferably applies one or more Boolean operators 106 and places, e.g., the highest value display 102 of each set 104a through 104c into the associated award display 108. The game therefore places the 90 value into the Award 1 display, the 55 value into the Award 2 display and the 125 value into the Award 3 display. The game alternatively places the lowest value display 102 or an intermediate value display 102 from each set 104a through 104c into the associated award display 108. The game further alternatively does not apply a Boolean operator 106 and randomly places a value display 102 into the associated award display 108. The alternative embodiment also includes placing values in the award displays 108 individually after the game completes a set 104a through 104c or collectively after the game completes all the sets.

The game then alternatively employs another one or more Boolean operators 106 and places, e.g., the highest award display 108 into the paid display 112. The game therefore places the 125 award into the paid display 112. The game alternatively places the lowest award display 108 or an intermediate award display 108 into the paid display 112. The game further alternatively does not apply a Boolean operator 106 and randomly places an award in one of the award displays 108 into the paid display 112. The game also provides the resulting amount of credits or multipliers or other gaming device award such as a number of picks from a prize pool to the player and enables the player to cash out and redeem an amount of credits generated by the resulting amount.

### Second Alternative Embodiment

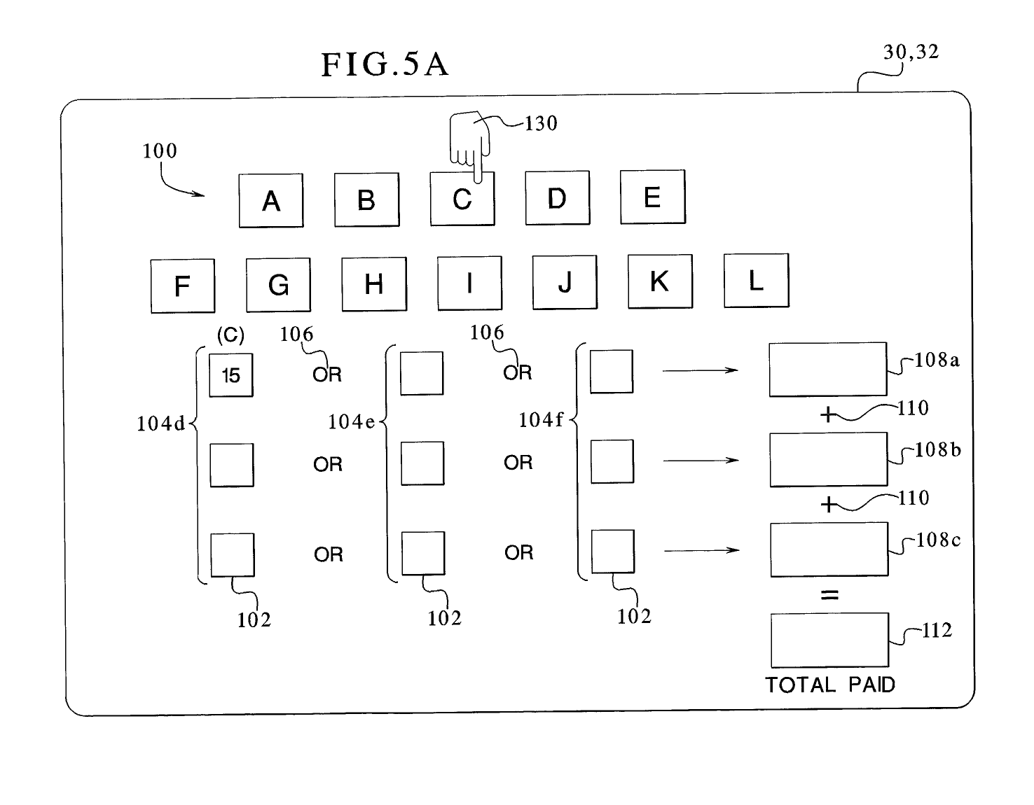

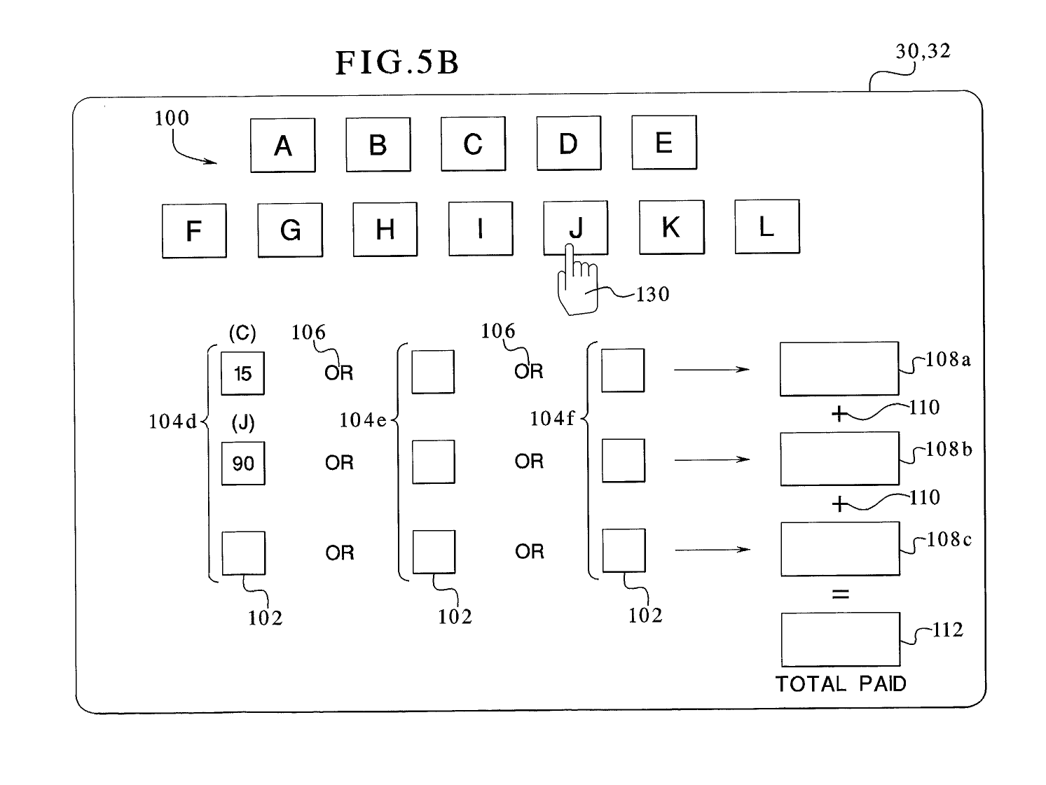

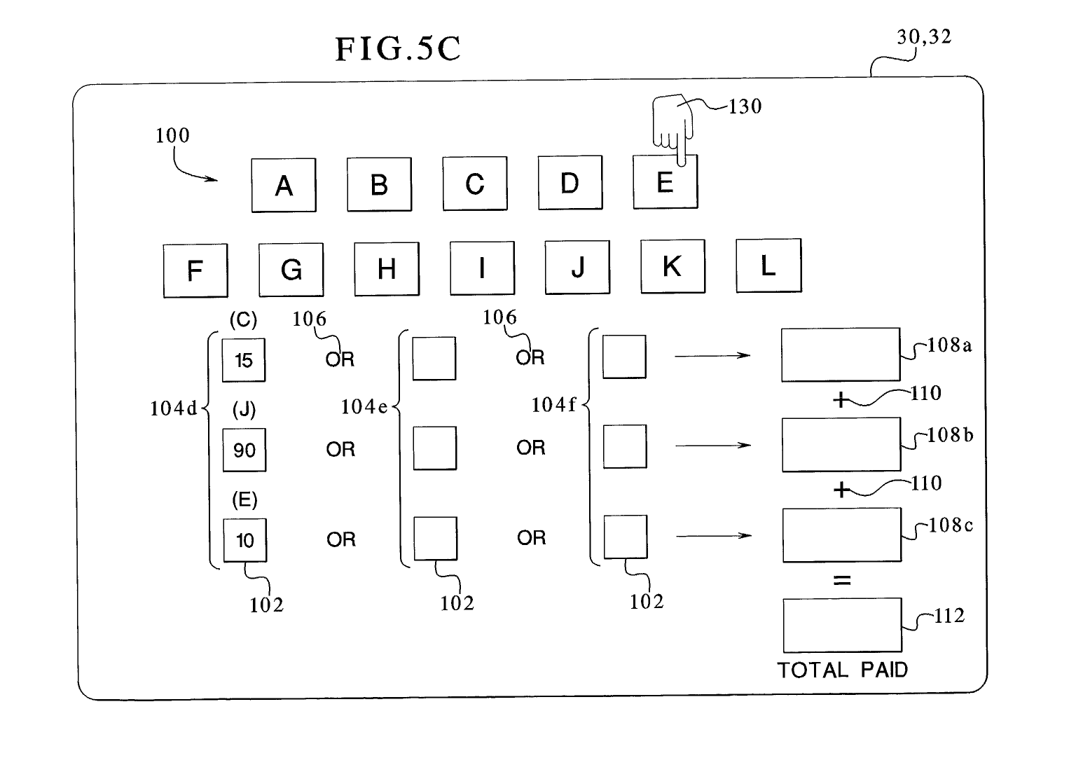

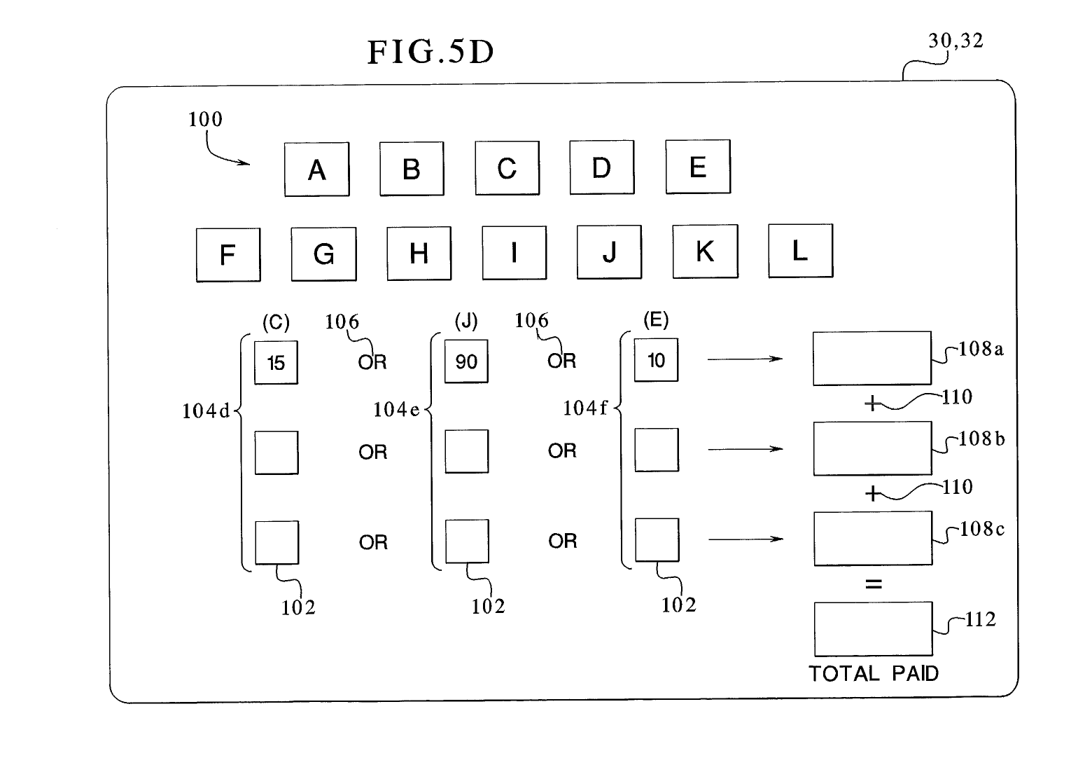

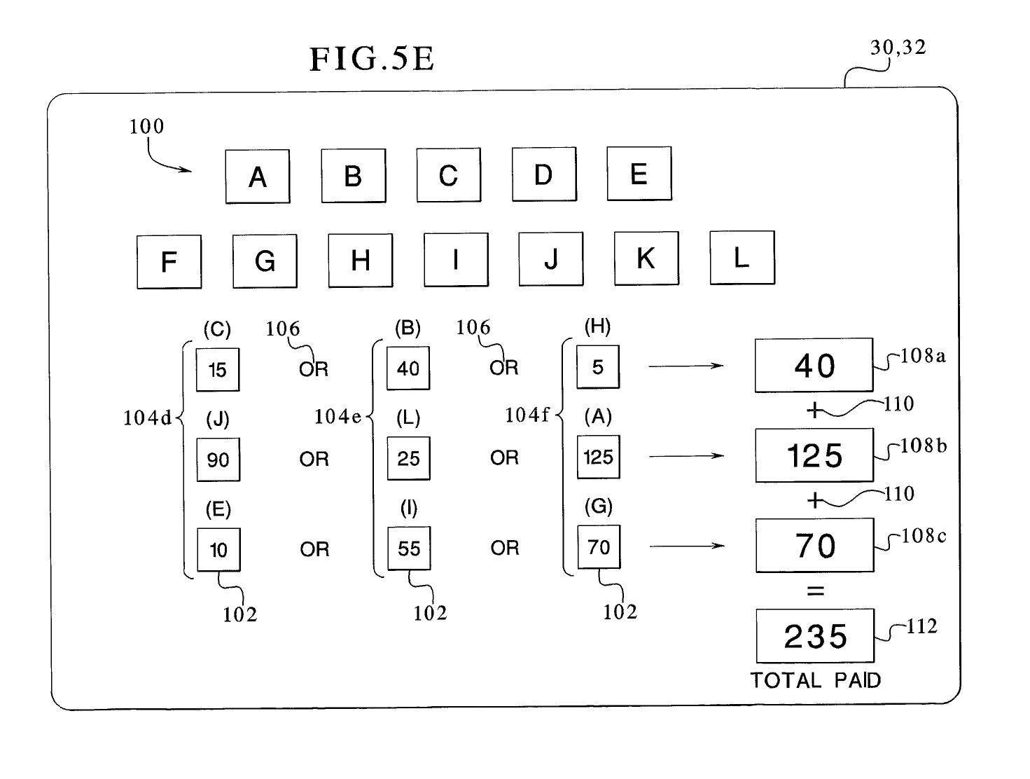

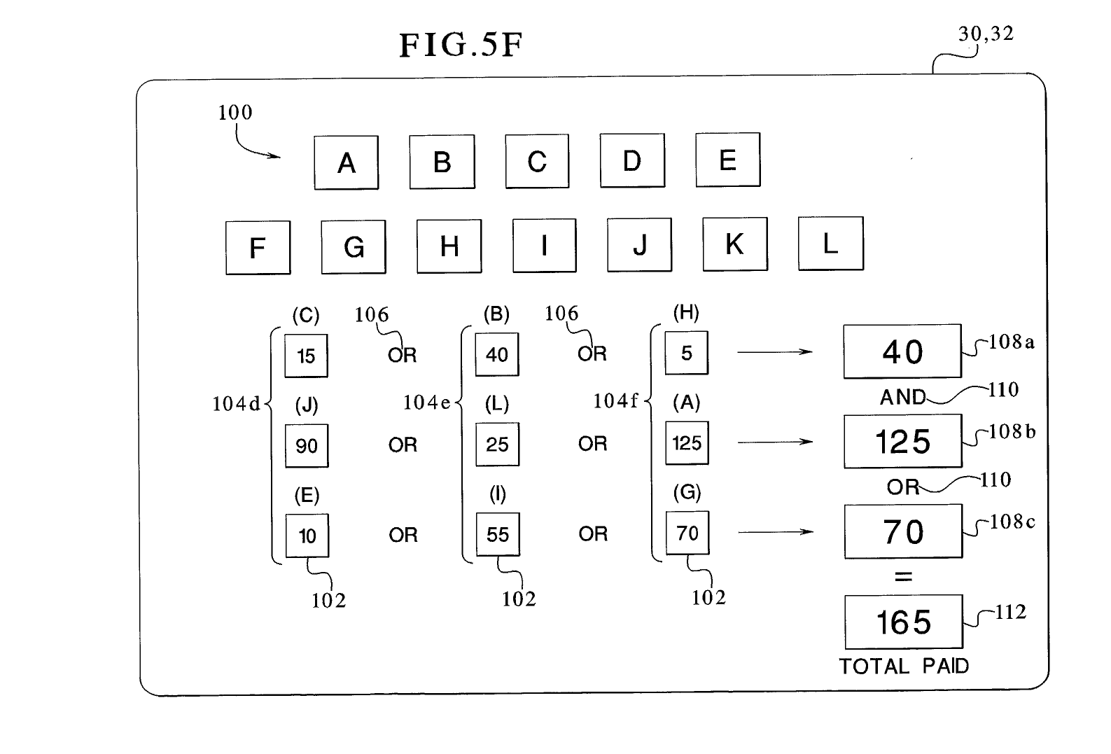

Referring now to FIGS. 5A through 5E, an alternative embodiment of the present invention is illustrated, wherein the game compares and selects awards from values of different independent sets of values and modifies the selected awards. Referring to FIG. 5A and assuming the game employs the table 120 of FIG. 4A, when the player 130 first selects the “C” input, the game displays the associated fifteen value (and any accompanying indicia) in the value set 104d, which is not associated with a particular award, as above, but which is a set of values discrete from the sets 104e and 104f. FIG. 5A illustrates the “C” in parentheses above the value display 102 having the value fifteen for clarification purposes, as above.

Referring now to FIG. 5B, the player 130 selects the “J” input second, and the game displays the associated ninety value (and any accompanying indicia) in the same value set 104d. Referring now to FIG. 5C, the player 130 selects the “E” input third, and the game displays the associated ten value (and any accompanying indicia) in the now completed set 104d.

The alternative embodiment of FIGS. 5A through 5E contemplates displaying values for and completing value sets 104d through 104f one at a time, as indicated by the FIGS. 5A through 5C. FIG. 5D illustrates an alternative method of distributing the same first three picks, wherein the game places the fifteen value associated with the first pick “C” in the value set 104d, as done previously. The game however places the ninety value associated with the second pick “J” in the value set 104e. The game places the ten value associated with the third pick “E” in the value set 104f. The alternative embodiment includes employing any predetermined value placement order or further alternatively randomly deploying the values in the various sets 104d through 104f.

Referring now to FIG. 5E and assuming the game completes one set at a time as illustrated in FIGS. 5A through 5C and employs the value table 120 of FIG. 4A, upon making nine allowable selections, the game completed the set 104e after the player selected the “B,” the “L” and the “I” and the set 104f after the player selected the “H,” the “A” and the “G.” In the alternative embodiment of FIGS. 5A through 5E, the game applies one or more Boolean operators 106 and preferably places the highest value display 102 of each set 104d through 104f into an award display 108. The game therefore places the 40 value into the award display 108a, the 125 value into the award display 108b and the 70 value into the award display 108c.

The game alternatively applies one or more Boolean operators 106 and places the lowest value display 102 or an intermediate value display 102 from each set 104d through 104f into an award display 108. The game further alternatively does not apply a Boolean operator 106 and randomly places a value display 102 into an award display 108.

The game then: (i) performs one or more mathematical operations as indicated by operators 106, with any two or more awards until performing a mathematical operation with each award; (ii) displays the result of applying one or more mathematical operations with the awards in the paid display 112; and (iii) provides the resulting amount of credits or multipliers or other gaming device award to the player. In FIG. 5E, as preferred, the game adds all three awards together, but alternatively multiplies all three awards, etc. The alternative embodiment of FIGS. 5A through 5E includes performing any mathematical operation such as addition, subtraction, multiplication, division, any combination thereof or other suitable operation or calculation.

### Third Alternative Embodiment

Referring now to FIG. 5F, an alternative embodiment of the present invention is illustrated, wherein the game compares and selects awards from values of different graphically independent sets of values and compares the selected awards. The embodiment of FIG. 5F includes employing any predetermined value placement or alternatively randomly deploying the values in the various sets 104d through 104f. Assuming the game completes one set at a time as in FIGS. 5A through 5C and employs the value table 120 of FIG. 4A, upon making nine allowable selections, the game completes the sets 104d through 104f as displayed.

In the alternative embodiment of FIG. 5F, the game preferably applies one or more Boolean operators 106 and places, e.g., the highest value display 102 of each set 104d through 104f into an award display 108a through 108c. The sets 104d through 104f are not individually associated with a particular award, but are sets of values discrete from the other sets. The game therefore places the 40 value into the award display 108a, the 125 value into the award display 108b and the 70 value into the award display 108c. The game alternatively places the lowest value display 102 or an intermediate value display 102 from each set 104d through 104f into an award display. The game further alternatively does not apply a Boolean operator 106 and randomly places a value display 102 into an award display 108.

The game then employs another one or more Boolean operators 106 and places, e.g., the higher of (award display 108a AND award display 108b) OR (award display 108c) into the paid display 112. The game therefore places the 40 AND 125 (i.e., 165) award into the paid display 112 because it is higher than 70. The Boolean operators 106 may also be employed to place, e.g., the higher of award display 108a AND (award display 108b OR award display 108c) into the paid display 112. Here, the game again places the 40 and 125 award into the paid display 112 because the game chooses the higher of 125 or 70 to combine with 40.

The game further alternatively places the highest or lowest of the award displays 108a through 108c or an intermediate award display into the paid display 112. The game further alternatively does not apply a Boolean operator 106 and randomly places an award display 108 into the paid display 112. The game also provides the resulting amount of credits or multipliers or other gaming device award, such as a number of picks from a prize pool to the player and enables the player to cash out and redeem an amount of credits generated by the resulting amount.

### Fourth Alternative Embodiment

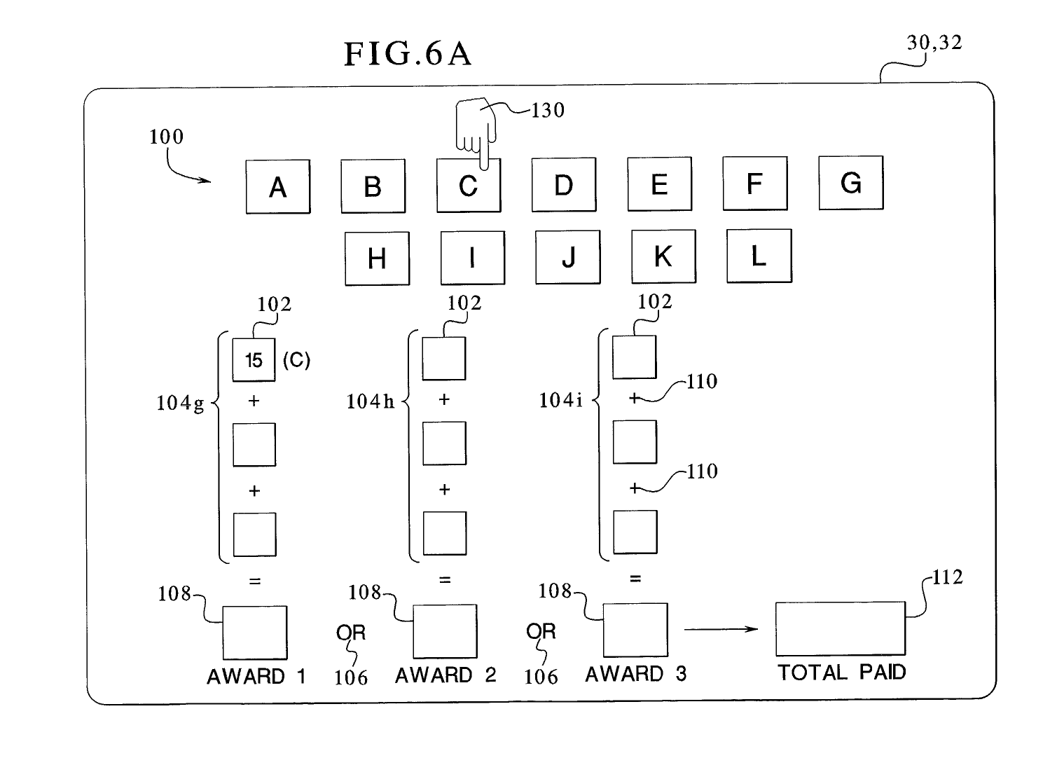

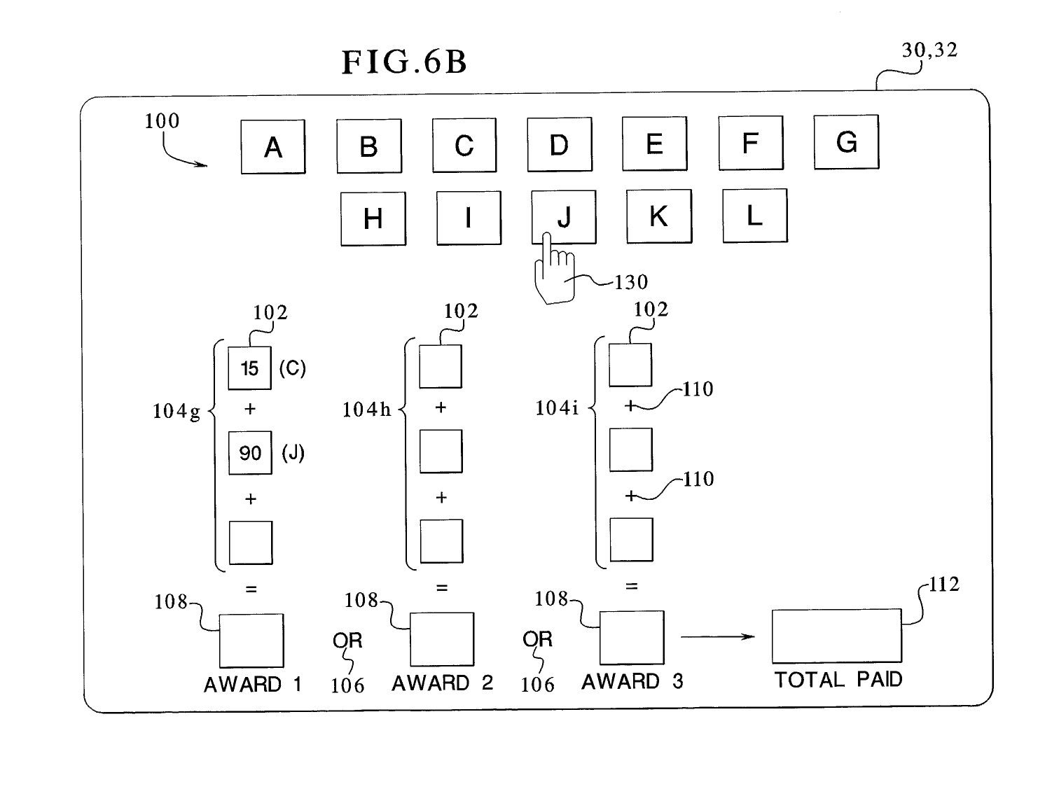

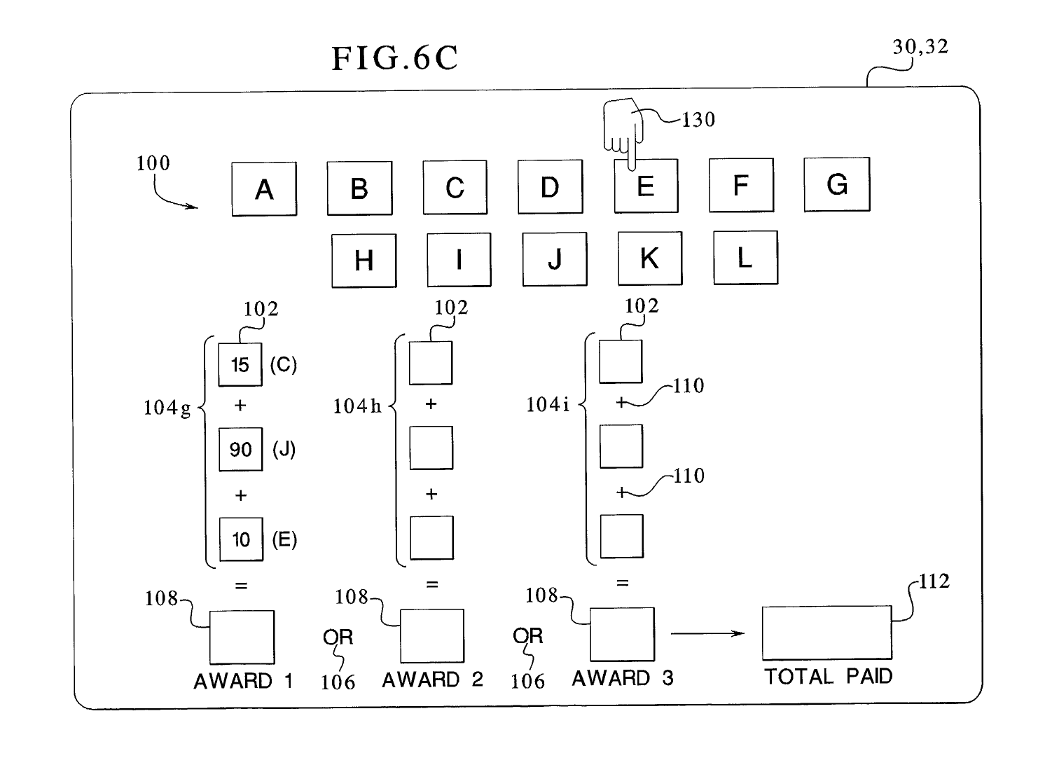

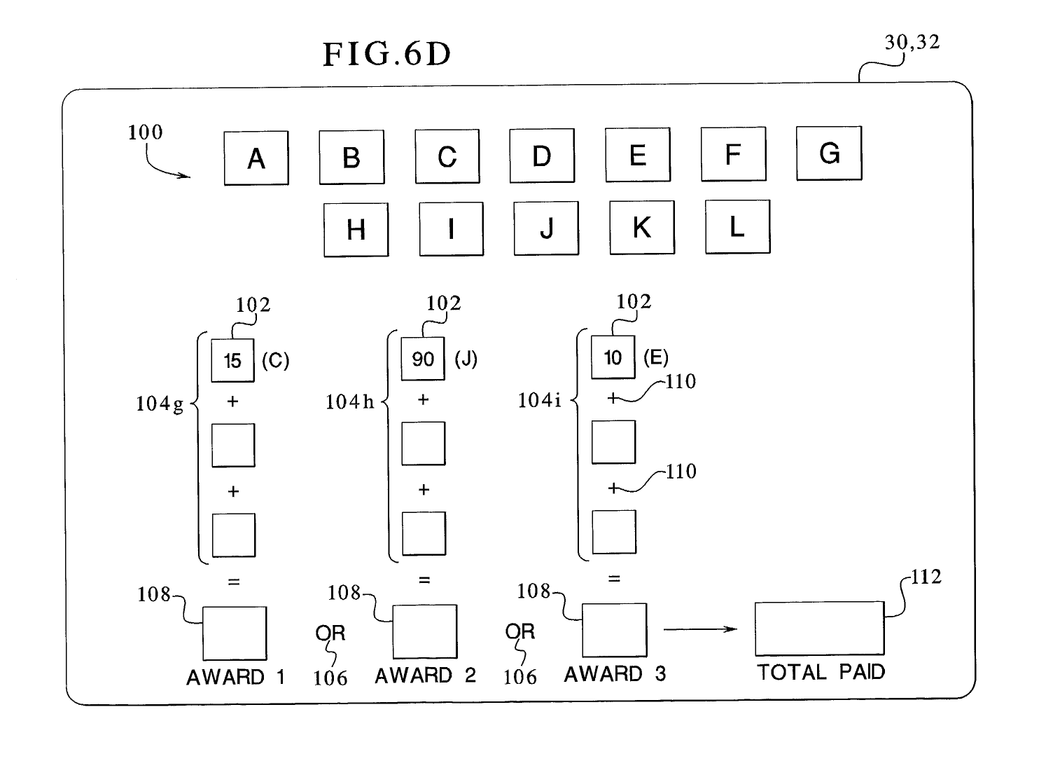

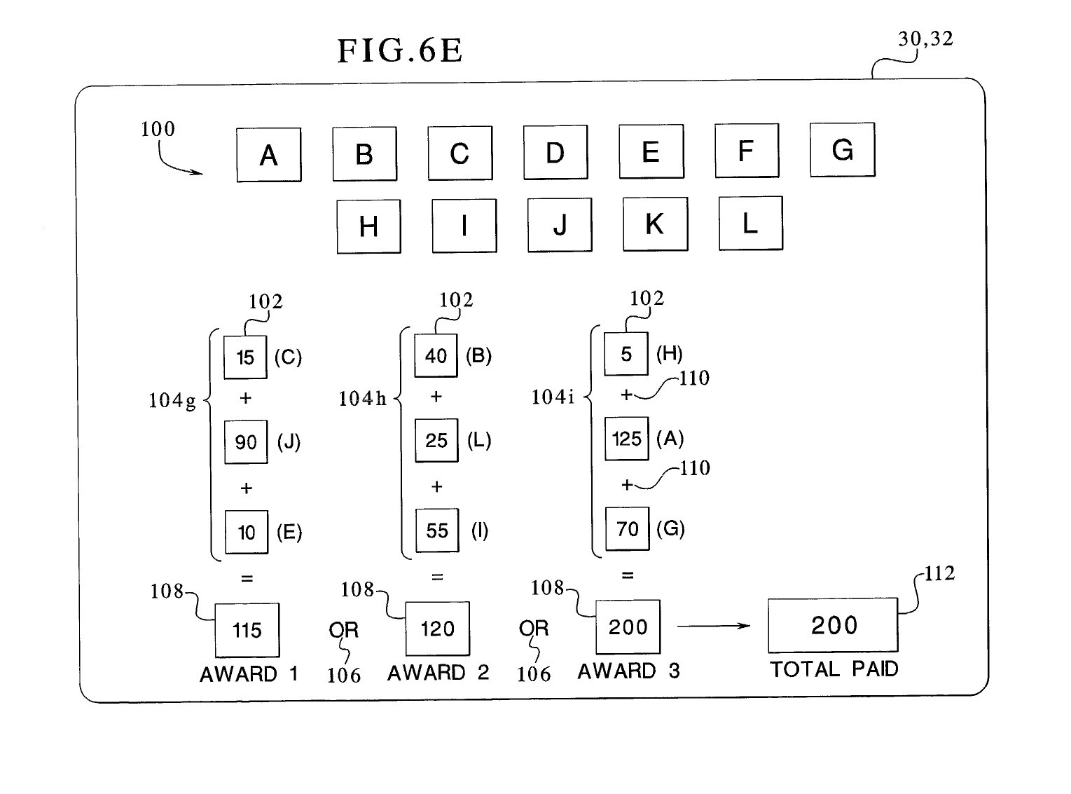

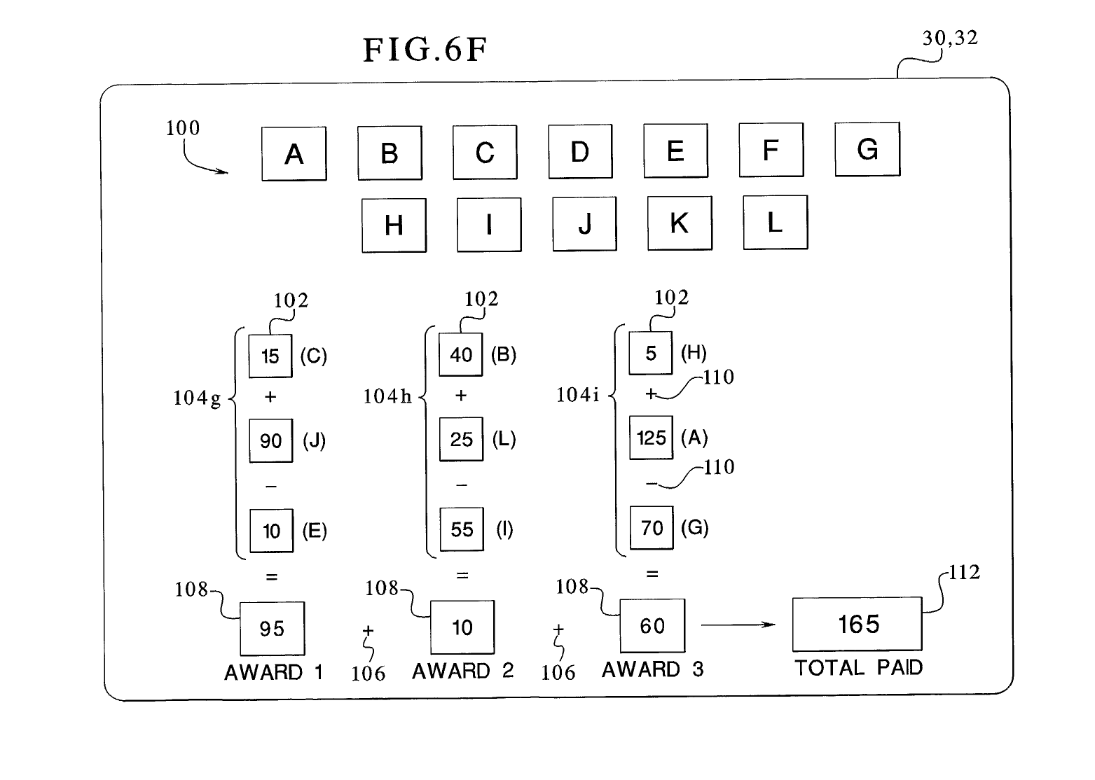

Referring now to FIGS. 6A through 6E, an alternative embodiment of the present invention is illustrated, wherein the game modifies values of a plurality of sets of values to form awards and compares the awards. Referring to FIG. 6A and assuming the game employs the table 120 of FIG. 4A, when the player 130 first selects the “C” input, the game displays the associated fifteen value (and any accompanying indicia) in the value set 104 associated with Award 1. FIG. 6A illustrates the “C” in parentheses to the right of the value display 102 having the value fifteen for clarification purposes, as above.

Referring now to FIG. 6B, the player 130 selects the “J” input second, and the game displays the associated ninety value (and any accompanying indicia) in the same value set 104g associated with Award 1. Referring now to FIG. 6C, the player 130 selects the “E” input third, and the game displays the associated ten value (and any accompanying indicia) in the now completed set 104g associated with Award 1.

The alternative embodiment of FIGS. 6A through 6E contemplates displaying values for and completing value sets 104g to 104i one at a time, as indicated by the FIGS. 6A through 6C. FIG. 6D illustrates an alternative method of distributing the same first three picks, wherein the game places the fifteen value associated with the first pick “C” in the value set 104g associated with the Award 1, as done previously. The game however places the ninety value associated with the second pick “J” in the value set 104h associated with the Award 2. The game places the ten value associated with the third pick “E” in the value set 104i associated with the Award 3. The alternative embodiment includes employing any predetermined value placement or further alternatively randomly deploying the values in the various sets 104.

Referring now to FIG. 6E and assuming the game completes one set at a time as in FIGS. 6A through 6C and employs the value table 120 of FIG. 4A, upon making nine allowable selections, the game completed the set 104h of Award 2 after the player selected the “B,” the “L” and the “I” and the set 104i of Award 3 after the player selected the “H,” the “A” and the “G.” In the alternative embodiment of FIGS. 6A through 6E, the game then: (i) performs one or more mathematical operations indicated by operators 110, between any two or more values 102 of a set 104g to 104i until applying a mathematical operation to each of the values 102 of a set 104g to 104i; and (ii) displays the result of performing one or more mathematical operation with the values in an award display 108.

In FIG. 6E, as preferred, the game adds all three values 102 together, but alternatively multiplies all three values, etc. The alternative embodiment of FIGS. 6A through 6E includes performing any mathematical operation indicated by operator 110, such as addition, subtraction, multiplication, division, any combination thereof or any other suitable operation or calculation.

The game then preferably: (i) applies one or more Boolean operators 106 and picks the highest value award displayed in the award displays 108; (ii) displays the result of applying the logical operator in the paid display 112; and (iii) provides the resulting amount of credits or multipliers or other gaming device award to the player. The game therefore places the 200 award into the paid display 112. The game alternatively applies one or more Boolean operators 106 and places the lowest value award or an intermediate value award into the paid display 112. The present invention further includes not applying a Boolean operator 106 and randomly placing an award in the paid display 112.

### Fifth Alternative Embodiment

Referring now to FIG. 6F, an alternative embodiment of the present invention is illustrated, wherein the game modifies values of a plurality of sets of values to form awards and modifies the awards. The embodiment of FIG. 6F includes employing any predetermined value placement or alternatively randomly deploying the values in the various sets 104. Assuming the game completes one set at a time as in FIGS. 6A through 6C and employs the value table 120 of FIG. 4A, upon making nine allowable selections, the game completes the sets 104 as displayed.

In the alternative embodiment of FIG. 6F, the game then: (i) performs one or more mathematical operation indicated by operator 110, between any two or more values 102 of a set 104g to 104i; until performing a mathematical operation with each of the values 102 of a set 104g to 104i; and (ii) displays the result of performing one or more mathematical operations with the values in an award display 108. In FIG. 6F, the game adds the top two values 102 and subtracts the bottom value 102. The alternative embodiment of FIG. 6F includes performing any mathematical operation such as addition, subtraction, multiplication, division, any combination thereof or any other suitable operation or calculation.

The game then preferably: (i) again performs one or more mathematical operations indicated by operators 110, between any two or more award displays 108 until performing a mathematical operation with each of the award displays 108; and (ii) displays the result of performing one or more mathematical operations with the values in an total paid display 112. In FIG. 6F, as preferred, the game adds all three award displays 108 together, but alternatively multiplies all three values, etc. The alternative embodiment of FIG. 6F includes performing any mathematical operation with the award displays such as addition, subtraction, multiplication, division, any combination thereof or any other suitable operation or calculation. The game also provides the resulting amount of credits or multipliers or other gaming device award such as a number of picks from a prize pool to the player and enables the player to cash out and redeem an amount of credits generated by the resulting amount.

### Sixth Alternative Embodiment

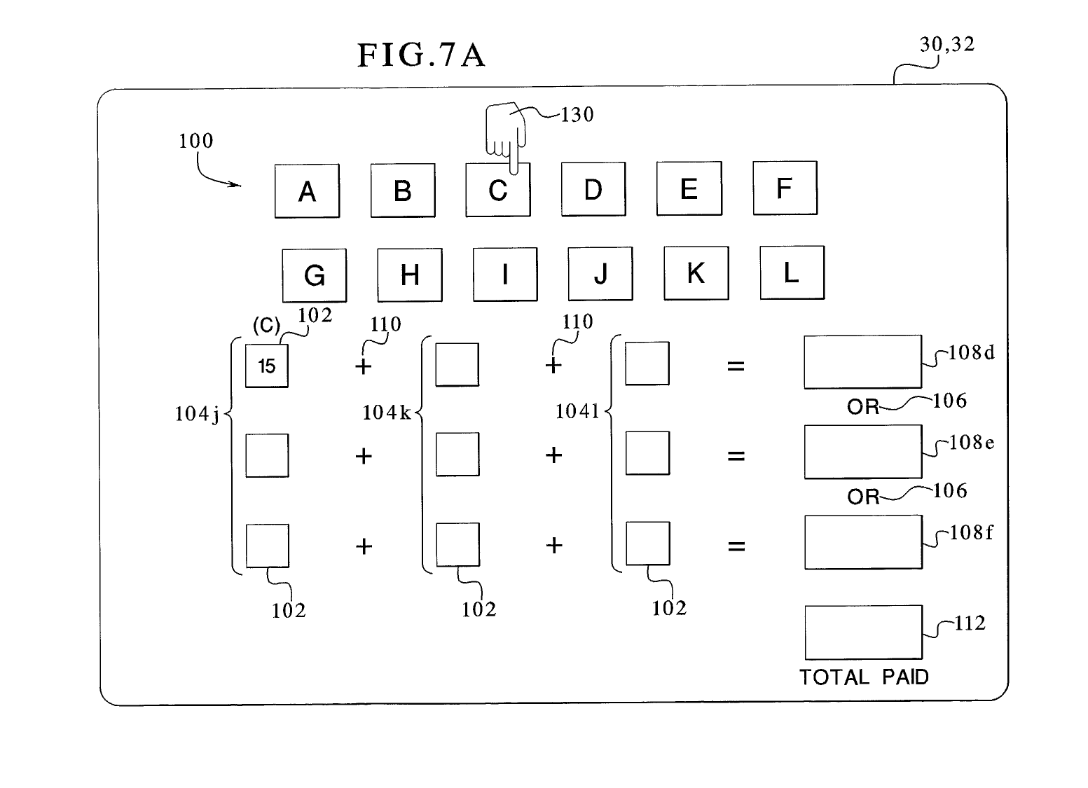

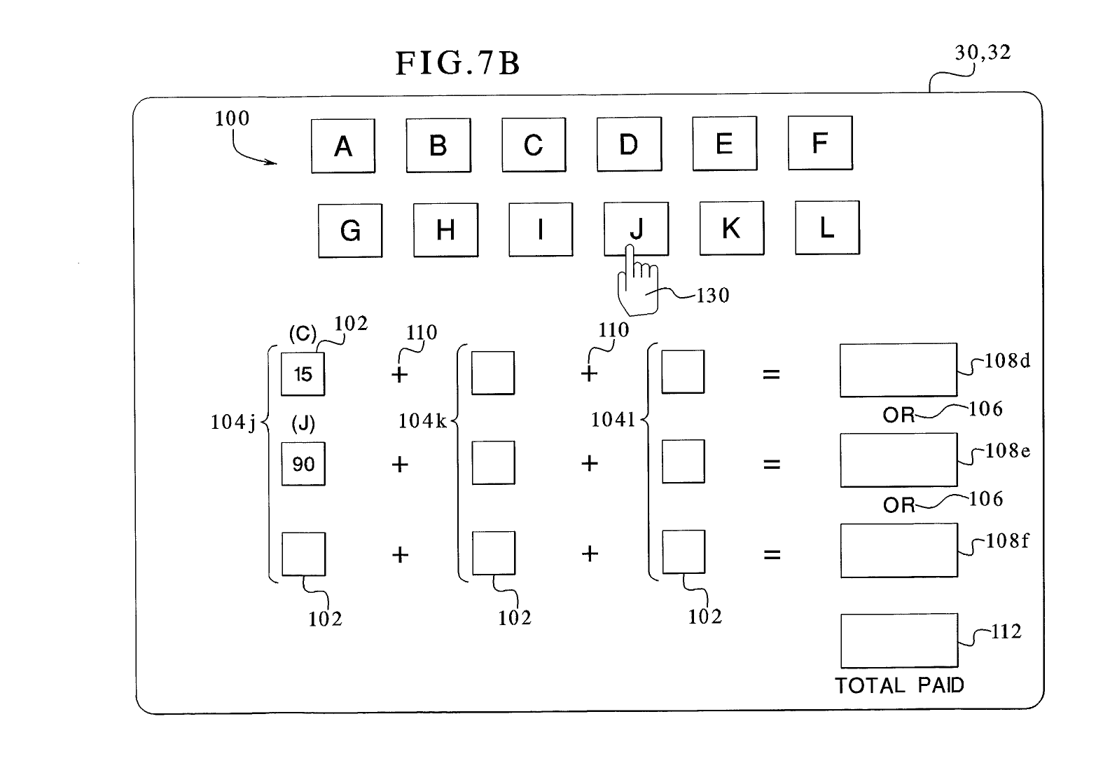

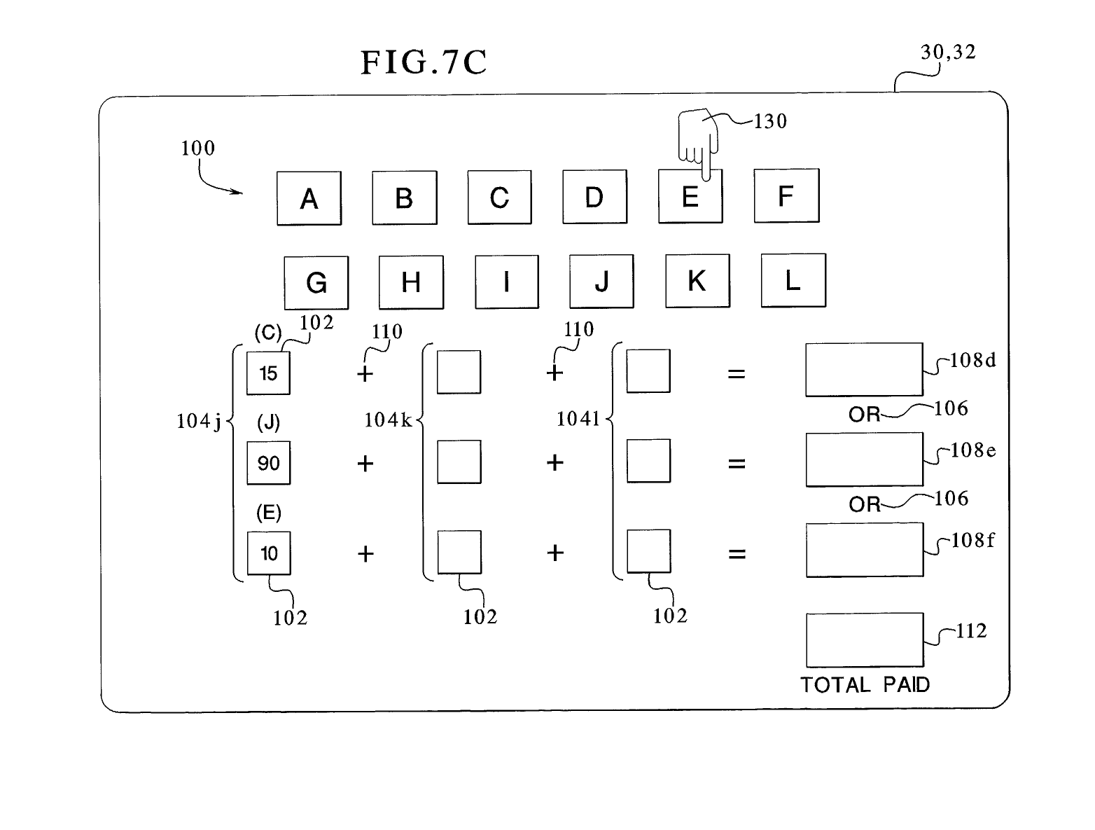

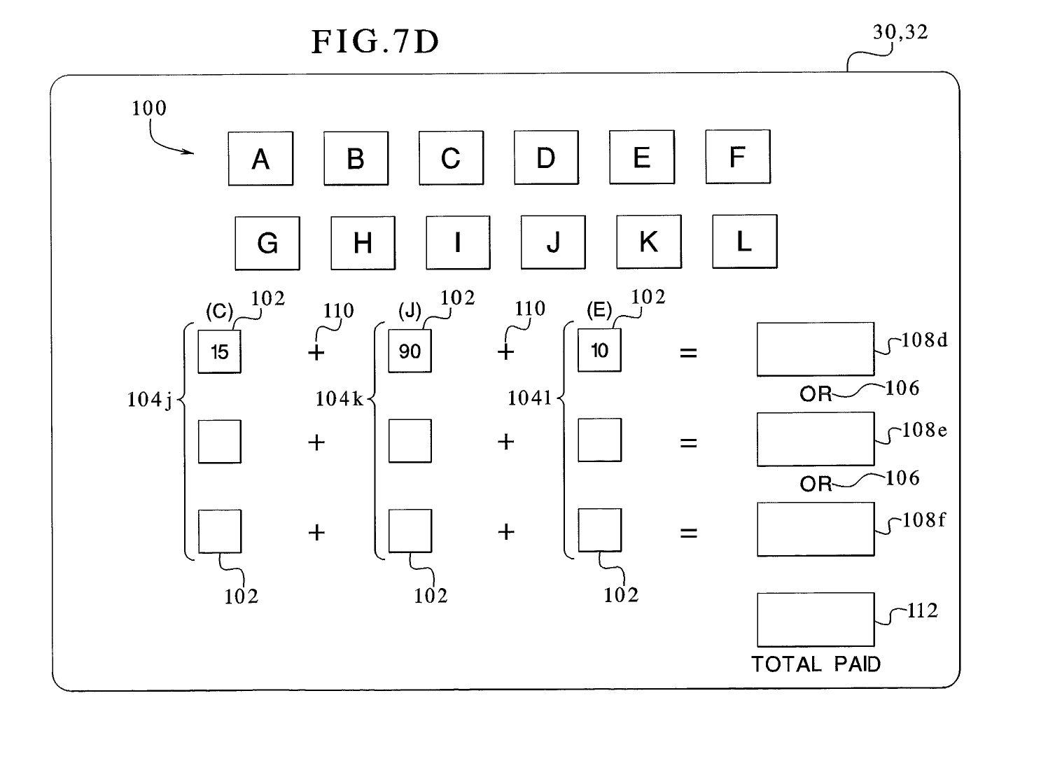

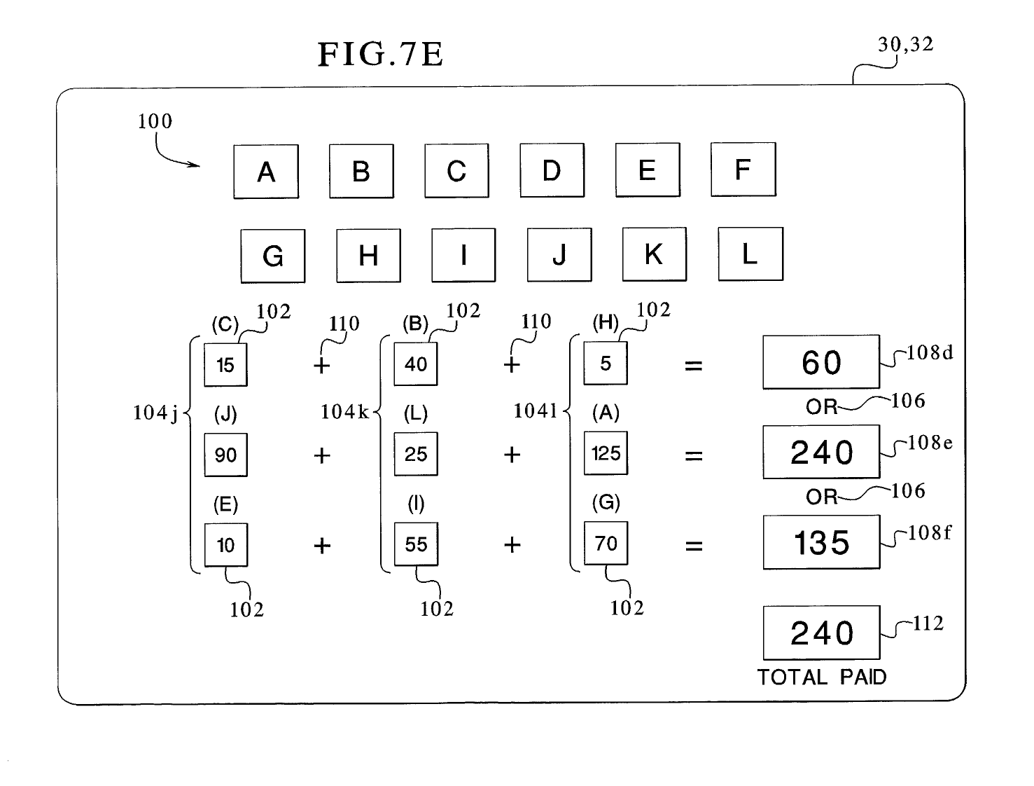

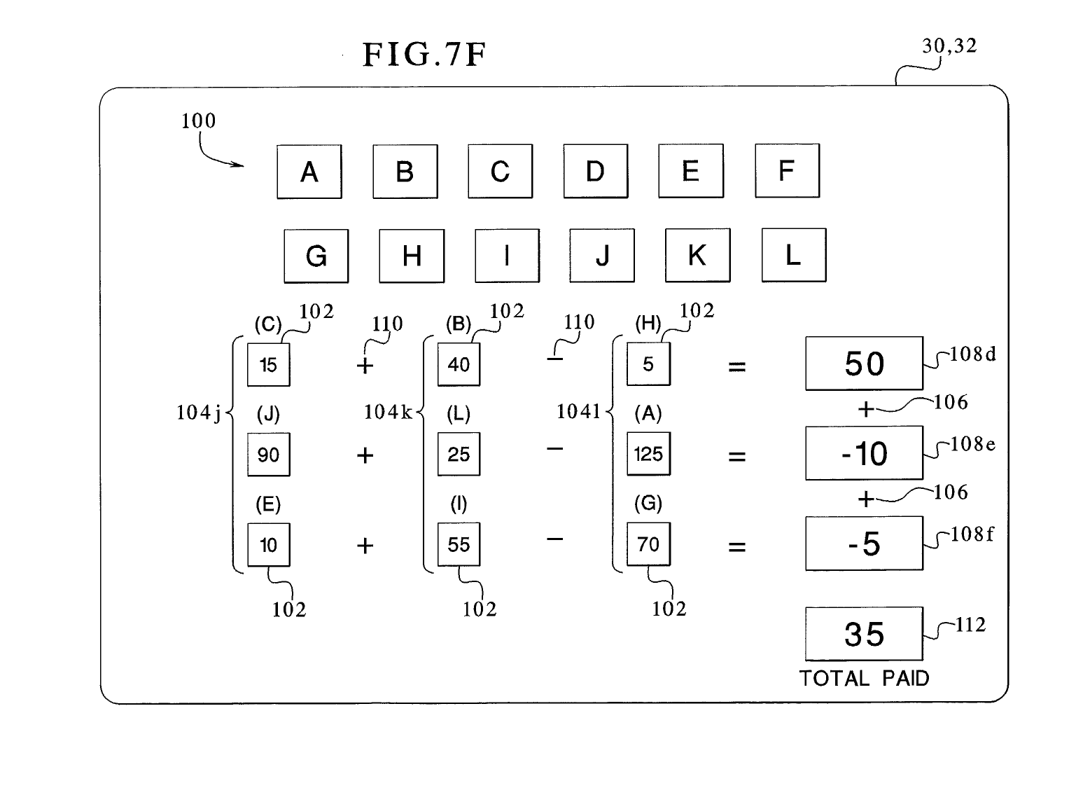

Referring now to FIGS. 7A through 7E, an alternative embodiment of the present invention is illustrated, wherein the game modifies values from different independent sets of values to form awards and compares the awards. Referring to FIG. 7A, and assuming the game employs the table 120 of FIG. 4A, when the player 130 first selects the “C” input, the game displays the associated fifteen value (and any accompanying indicia) in the value set 104j, which is not associated with a particular award, but which is a set of values discrete from the sets 104k and 104l. FIG. 5A illustrates the “C” in parentheses above the value display 102 having the value fifteen for clarification purposes, as above.

Referring now to FIG. 7B, the player 130 selects the “J” input second, and the game displays the associated ninety value (and any accompanying indicia) in the same value set 104j. Referring now to FIG. 7C, the player 130 selects the “E” input third, and the game displays the associated ten value (and any accompanying indicia) in the now completed set 104j.

The alternative embodiment of FIGS. 7A through 7E contemplates displaying values for and completing value sets 104j through 104l one set at a time, as indicated by the FIGS. 7A through 7C. FIG. 7D illustrates an alternative method of distributing the same first three picks, wherein the game places the fifteen value associated with the first pick “C” in the value set 104j, as done previously. The game however places the ninety value associated with the second pick “J” in the value set 104k. The game places the ten value associated with the third pick “E” in the value set 104l. The alternative embodiment includes employing any predetermined value placement or further alternatively randomly deploying the values in the various sets 104j through 104l.

Referring now to FIG. 7E and assuming the game completes one set at a time as in FIGS. 7A through 7C and employs the value table 120 of FIG. 4A, upon making nine allowable selections, the game completed the set 104h after the player selected the “B,” the “L” and the “I” and the set 104i after the player selected the “H,” the “A” and the “G.” In the alternative embodiment of FIGS. 7A through 7E, the game then: (i) employs one or more mathematical operations indicated by operators 110, between any two or more values 102 of different sets 104j through 104l and (ii) displays the result of performing one or more mathematical operators with the values in an award display 108d through 108f.

In FIG. 7E, as preferred, the game adds all three values 102 together, but alternatively multiplies all three values, etc. The alternative embodiment of FIGS. 7A through 7E includes performing any mathematical operation indicated by operators 110, such as addition, subtraction, multiplication, division, any combination thereof or any other suitable operation or calculation.

The game then preferably: (i) applies one or more Boolean operators 106 and picks the highest value award displayed in the award displays 108; (ii) displays the result of applying the logical operator in the paid display 112; and (iii) provides the resulting amount of credits or multipliers or other gaming device award to the player. The game therefore places the 240 award into the paid display 112. The game alternatively applies one or more Boolean operators 106 and places the lowest value award or an intermediate value award into the paid display 112. The present invention further includes not applying a Boolean operator 106 and randomly placing an award in the paid display 112.

### Seventh Alternative Embodiment

Referring now to FIG. 7F, an alternative embodiment of the present invention is illustrated, wherein the game modifies values from different graphically independent sets of values to form awards and modifies the awards. The embodiment of FIG. 7F includes employing any predetermined value placement or alternatively randomly deploying the values in the various sets 104j through 104l. Assuming the game completes one set at a time as in FIGS. 7A through 7C and employs the value table 120 of FIG. 4A, upon making nine allowable selections, the game completes the sets 104j through 104l as displayed.

In the alternative embodiment of FIG. 7F, the game then: (i) performs one or more mathematical operations indicated by operators 110, between any two or more values 102 of different sets 104g through 104i until a mathematical operation has been performed with each value 102; and (ii) displays the result of performing one or more mathematical operations with the values in one of the award displays 108d though 108f. In FIG. 7F, the game adds the left two values 102 and subtracts the right value 102 as illustrated. The alternative embodiment of FIG. 7F includes performing any mathematical operator 110 such as addition, subtraction, multiplication, division, any combination thereof or any suitable operation or calculation.

The game then preferably: (i) performs one or more mathematical operations indicated by operators 106, between any two or more award displays 108d through 108f until performing a mathematical operation with each of the award displays; and (ii) displays the result of performing one or more mathematical operations with the values in an total paid display 112. In FIG. 7F, as preferred, the game adds all three award displays 108 together, but alternatively multiplies all three values, etc. The alternative embodiment of FIG. 7F includes performing any mathematical operation with the award displays such as addition, subtraction, multiplication, division, any combination thereof or any suitable operation or calculation. The game also provides the resulting amount of credits or multipliers or other gaming device award, such as a number of picks from a prize pool, to the player and enables the player to cash out and redeem an amount of credits generated by the resulting amount.

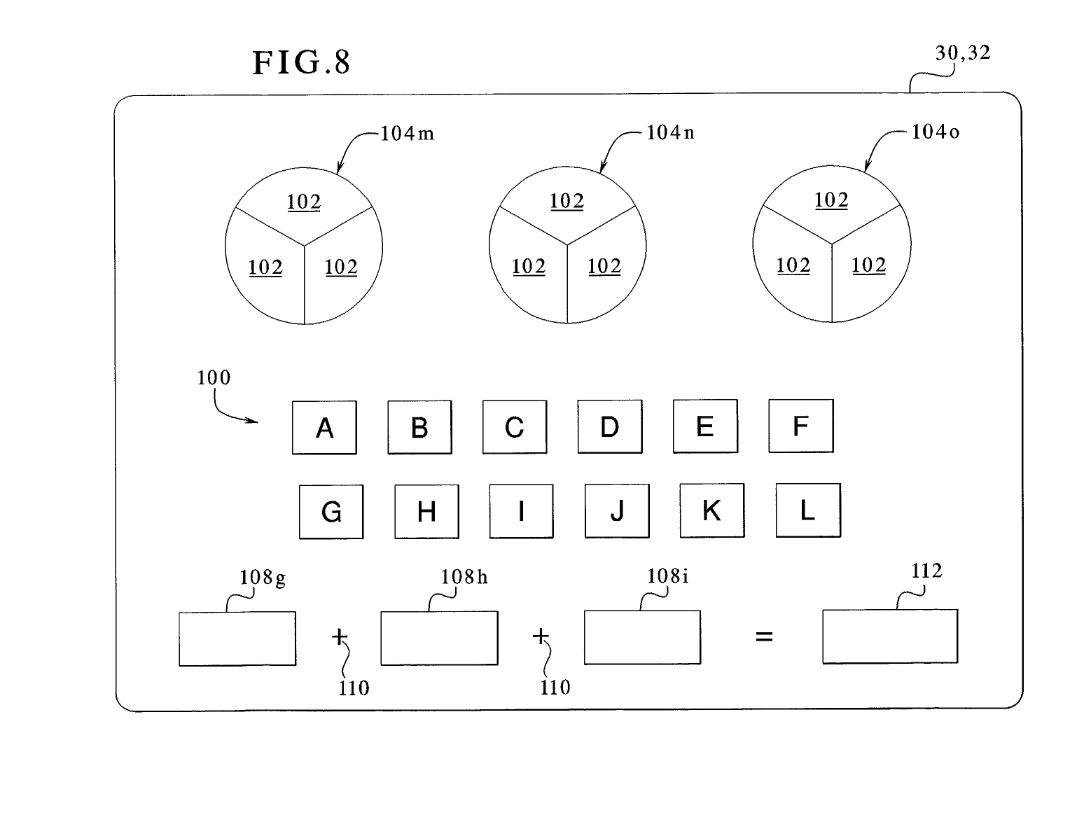

Referring now to FIG. 8, one another embodiment of the present invention is illustrated. The game performs one or more Boolean operations to the values generated for each display 102 in the sets 104m through 104o. The display 30, 32 includes a plurality of award displays 108g through 108i, corresponding to the sets 104m through 104o, in which the game places the highest value generated from each set 104m through 104o. That is, the game performs a Boolean operation by picking one displayed value 102 OR another displayed value OR a third, preferably the highest one, from each set.

Each of the circular sets 104m through 104o includes a circle or a dish. When the player selects an input 100, e.g., one of inputs A through L, the game displays a food item in one of the displays 102 of one of the dishes or sets 104m through 104o. Each of the food items has an associated value.

When each set is complete, the game performs the above described Boolean operation on the values corresponding to each food item of each set 104m through 104o and preferably places the highest value in the corresponding award display 108g through 108i. The game performs a mathematical operation as indicated by the operators 106, whereby the game preferably adds each of the highest values of the sets, displayed in the award displays 108g through 108i. The sum equals the players award displayed in the paid display 112.

It should be appreciated that the preferred display embodiment of FIG. 8 is adaptable for any of the seven alternative embodiments described above. For instance, one embodiment includes taking the highest value from three meat items respectively displayed in each set, 104m through 104g, and placing the highest value in an award display 108g through 108i. This embodiment likewise places the highest vegetable item value and starch item value in the remaining award displays. The game of this embodiment sums the displayed award to form the player's award in the paid display 112.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is hereby claimed as follows:

1. A gaming device comprising:
a display device;
a processor in communication with the display device;
a plurality of inputs adapted to be displayed to a player by the display device and a plurality of values associated with the inputs;
at least one set of values determined by the player's selection of the inputs; and
at least one award generated by the processor by applying a Boolean OR operator to the values of the set.

2. The gaming device of claim 1, wherein the Boolean OR operator generates the largest value of the set.

3. The gaming device of claim 1, which includes a plurality of sets that each yield an award by applying a Boolean OR operator to the sets and a resulting award provided to the player generated by the processor by performing at least one mathematical operation on the awards from the sets.

4. The gaming device of claim 1, which includes a plurality of sets that each yield an award by applying a Boolean OR operator to the sets and a resulting award provided to the player generated by applying at least one Boolean operator to the awards from the sets.

5. The gaming device of claim 4, wherein the at least one Boolean operator applied to form the resulting award is selected from: OR and AND.

6. A gaming device comprising:
a display device;
a processor in communication with the display device;
a plurality of inputs adapted to be displayed to a player by the display device and a plurality of values associated with the inputs;
a plurality of sets of values determined by the player's selection of the inputs;
a plurality of awards generated by applying a Boolean OR operator to the values of said sets; and
a resulting award generated by the processor by performing at least one mathematical operation on the awards generated from the sets.

7. The gaming device of claim 6, wherein the display device displays the inputs and reveals values associated with inputs that are not selected by the player.

8. A gaming device comprising:
a display device;
a processor in communication with the display device;
a plurality of inputs adapted to be displayed by the display device to a player and a plurality of values associated with the inputs;
a plurality of sets of values determined by the player's selection of the inputs;
a plurality of awards generated by the processor by applying at least one Boolean operator to the values of the sets; and
a resulting award generated by the processor by applying at least one Boolean operator to the awards from the sets.

9. A gaming device comprising:
a display device;
a processor in communication with the display device;
a plurality of inputs adapted to be displayed to a player by the display device and a plurality of values associated with the inputs;
a plurality of sets of values determined by a player's selection of the inputs; and
a plurality of awards generated by the processor by applying at least one Boolean OR operator to the values selected from different sets.

10. The gaming device of claim 9, wherein the Boolean OR operator generates the largest value of the at least one set.

11. The gaming device of claim 9, which includes a resulting award generated by performing at least one mathematical operation on the plurality of awards from the sets.

12. The gaming device of claim 9, which includes a resulting award generated by applying at least one Boolean operator to the plurality of awards from the sets.

13. The gaming device of claim 12, wherein the at least one Boolean operator applied to form the resulting award is selected from: OR and AND.

14. A gaming device comprising:
a display device;
a processor in communication with the display device;
a plurality of inputs adapted to be displayed to a player by the display device and a plurality of values associated with the inputs;
a plurality of sets of values determined by the player's selection of the inputs;
a plurality of awards generated by the processor by applying at least one Boolean OR operator values selected from different sets; and
a resulting award generated by the processor by performing at least one mathematical operation to the plurality of awards from the sets.

15. A gaming device comprising:
a display device;
a processor in communication with the display device;
a plurality of inputs adapted to be displayed to a player by the display device and a plurality of values associated with the inputs;
a plurality of sets of values determined by the player's selection of the inputs;
a plurality of awards generated by the processor by applying at least one Boolean operator to a plurality of values selected from different sets; and
a resulting award generated by the processor by applying at least one Boolean operator to the plurality of awards from the sets.

16. A gaming device comprising:
a display device;
a processor in communication with the display device;
a plurality of inputs adapted to be displayed to a player by the display device and a plurality of values associated with the inputs;
a plurality of sets of values determined by the player's selection of said inputs;
a plurality of awards generated by the processor by performing at least one mathematical operation on the values of the sets; and
a resulting award generated by the processor by applying at least one Boolean OR operator to the plurality of awards from the sets.

17. The gaming device of claim 16, wherein the Boolean OR operator generates the largest award from the sets.

18. A gaming device comprising:
a display device;
a processor in communication with the display device;
a plurality of inputs adapted to be displayed to a player by the display device and a plurality of values associated with the inputs;
a plurality of sets of values determined by the player's selection of the inputs;
a plurality of awards generated by the processor by performing a plurality of mathematical operations on values selected from different sets; and
a resulting award generated by the processor by applying at least one Boolean OR operator to the plurality of awards.

19. The gaming device of claim 17, wherein the mathematical operations are selected from the group consisting of: addition, subtraction, multiplication and division.

20. The gaming device of claim 18, wherein the Boolean OR operator generates the largest award from the sets.

21. A gaming device comprising:
a display device; and
a processor which communicates with the display device, the processor and the display device adapted to:
(a) display a plurality of inputs;
(b) generate values when a player picks the inputs;
(c) display the values in at least one set of values; and
(d) generate an award by applying a Boolean OR operator to the values in the at least one set.

22. The gaming device of claim 21, wherein the display device and the processor are adapted to apply the Boolean OR operator to the values and select the highest value.

23. A gaming device comprising:
a display device; and
a processor adapted to communicate with the display device, the display device and the processor adapted to:
(a) display a plurality of inputs;
(b) generate values when a player picks the inputs;
(c) display the values in a plurality of different sets of values;
(d) generate awards from the sets by performing at least one mathematical operation on values from the plurality of different sets; and
(e) generate a resulting award by applying at least one Boolean operator, including a Boolean OR operator, to the awards from the plurality of different sets.

24. The gaming device of claim 23, wherein the display device and the processor are adapted to apply the Boolean OR operator to a plurality of the awards and select the highest award from the plurality of awards.

25. A gaming device comprising:
a display device; and
a processor which communicates with the display device, the display device and the processor adapted to:
(a) display a plurality of inputs;
(b) generate values when a player picks the inputs;
(c) display the values in a plurality of different sets of values;
(d) generate awards from the sets by applying at least one Boolean operator to the values of the different sets, including a Boolean OR operator; and
(e) generate a resulting award by performing at least one mathematical operation on the awards from the plurality of different sets.
